(19) United States
(12) Patent Application Publication
(10) Pub. No.: US 2013/0027289 A1
(43) Pub. Date: Jan. 31, 2013

(54) ELECTRONIC DEVICE

(71) Applicants: Woosik Choi, Seoul (KR); Dami Choe, Seoul (KR)

(72) Inventors: Woosik Choi, Seoul (KR); Dami Choe, Seoul (KR)

(73) Assignee: LG Electronics Inc., Seoul (KR)

(21) Appl. No.: 13/191,786

(22) Filed: Jul. 27, 2011

(51) Int. Cl. G09G 5/00

(52) U.S. Cl. 345/156

(57) ABSTRACT

A mobile terminal is provided comprising a communication unit configured to form a network with first and second electronic devices, and a controller configured to control the first electronic device so that the first electronic device plays first content while simultaneously controlling playback of second content when receiving a connection request relating to playback of the second content from the second electronic device while controlling the first electronic device so that the first electronic device plays the first content.

### BACKGROUND

1. Technical Field

The embodiments of this document are directed to an electronic device, and more specifically to an electronic device that may control playback of first content while simultaneously controlling playback of second content when receiving a connection request relating to playback of the first content from another electronic device while controlling playback of the second content.

2. Related Art

Terminals have been appearing that may perform multiple functions, such as image capturing, playback of music or movie files, games, or receipt of broadcast.

The structure and/or software of the terminal may be modified for addition and improvement of functions. To meet the demand of provision of various functions, a terminal has a complicated menu configuration.

An electronic device attracts more interest that may control playback of content through a network that is formed together with other electronic devices based on a near-field wireless communication technology.

### SUMMARY

Exemplary embodiments of this document provide an electronic device that may control playback of first content while simultaneously controlling playback of second content when receiving a connection request relating to playback of the first content from another electronic device while controlling playback of the second content, such as, for example, by controlling the other electronic device to play the second content, by playing the second content, or by transmitting the second content to the other electronic device.

The present is not limited to the above embodiments. Other embodiments of this document will become apparent by one of ordinary skill in the art from the detailed description in conjunction with the accompanying drawings.

According to an embodiment of this document, there is provided an electronic device comprising a communication unit configured to form a network with first and second electronic devices, and a controller configured to control the first electronic device so that the first electronic device plays first content while simultaneously controlling playback of second content when receiving a connection request relating to playback of the second content from the second electronic device while controlling the first electronic device so that the first electronic device plays the first content.

According to an embodiment of this document, there is provided an electronic device comprising an output unit, a communication unit configured to form a network with a first electronic device, and a controller configured to play first content through the output unit while simultaneously controlling playback of second content when receiving a connection request relating to playback of the second content from the first electronic device while playing the first content through the output unit.

According to an embodiment, there is provided an electronic device comprising a communication unit configured to form a network with first and second electronic devices and a controller configured to transmit first content to the first electronic device while simultaneously controlling playback of second content when receiving a request for playing the second content from the second electronic device while transmitting the first content to the first electronic device.

According to the embodiments of this document, the electronic device may control a first electronic device to play first content while simultaneously controlling playback of second content in response to a connection request relating to playback of the second content that is received from a second electronic device.

Further, the electronic device may play the first content while simultaneously controlling playback of second content in response to a connection request relating to playback of the second content that is received from the second electronic device.

Also, the electronic device may transmit the first content to the second electronic device while simultaneously controlling playback of second content in response to a connection request relating to playback of the second content that is received from the second electronic device.

### BRIEF DESCRIPTION OF THE DRAWINGS

The embodiments of this document will become readily apparent by reference to the following detailed description when considered in conjunction with the accompanying drawings wherein:

FIG. 1 is a block diagram of an electronic device relating to an embodiment of this document;

FIG. 2 is a diagram illustrating a structure of a service network according to an embodiment of this document and a structure of a service network for sharing contents between electronic devices;

FIG. 3 is a conceptual diagram of a DLNA network;

FIG. 4 is a diagram illustrating a function component according to a DLNA.

FIG. 5 is a flowchart illustrating a method of controlling playback of content by a mobile terminal according to an embodiment of this document;

FIG. 6 is a flowchart illustrating a method of playing content by a mobile terminal according to an embodiment of this document;

FIG. 7 illustrates a process of transmitting the first content to the first electronic device in the content playing method described in connection with FIG. 6;

FIG. 8 illustrates an example where in the content playing method described in connection with FIG. 6, the second electronic device transmits a connection request relating to playback of the second content to the mobile terminal;

FIG. 9 illustrates an example where in the content playing method described in connection with FIG. 6, the mobile terminal makes a response to the received connection request relating to playback of the second content;

FIG. 10 illustrates an example of playing the second content according to the content playing method described in connection with FIG. 6;

FIG. 11 illustrates an example where a selection area is displayed on the display of the mobile terminal so that an electronic device may be selected to play the second content;

FIG. 12 illustrates an example where the second content is played according to the content playing method described in connection with FIG. 6;

FIG. 13 illustrates an example where the second content is played according to the content playing method described in connection with FIG. 6;

FIG. 14 illustrates an example where a selection area is displayed on the display of the mobile terminal to select an electronic device that may play the second content;

FIG. 15 illustrates an example where a selection area is displayed on the display of the mobile terminal to select an electronic device for playing the second content based on information on other electronic devices received from the mobile terminal, which may play the second content;

FIG. 16 illustrates an example of playing the second content according to the content playing method described in connection with FIG. 6;

FIG. 17 illustrates an example where the second content is played according to the content playing method described in connection with FIG. 6;

FIG. 18 illustrates an example where the mobile terminal plays first and second contents according to the content playing method described in connection with FIG. 6;

FIGS. 19 and 20 illustrate an example where the content playing area of the mobile terminal changes as the playback of content by the mobile terminal terminates according to the content playing method described in connection with FIG. 6;

FIG. 21 illustrates various screens displayed on the display of the mobile terminal while controlling playback of the first content;

FIG. 22 illustrates various screens displayed on the display of the mobile terminal while controlling playback of the first content;

FIG. 23 illustrates an example where transparency of the control area displayed on the display of the mobile terminal varies with time;

FIG. 24 illustrates an example where a content displaying area expands depending on variation of the transparency of the control area displayed on the display of the mobile terminal;

FIG. 25 illustrates an example where the control area displayed on the display of the mobile terminal varies with time;

FIGS. 26 to 28 illustrate an exemplary process of displaying a control area for controlling playback of content by the mobile terminal based on the location of a touch to the display that is implemented as a touch screen;

FIG. 29 is a flowchart illustrating a content playing method performed by the mobile terminal according to an embodiment of this document;

FIG. 30 illustrates an example where image and sound signals contained in the second content that is a movie file requested to play are played by different electronic devices, respectively;

FIG. 31 illustrates an example of controlling the first and second contents using different protocols by the mobile terminal;

FIG. 32 is a flowchart illustrating a content playing method performed by the mobile terminal according to an embodiment of this document;

FIG. 33 illustrates an example where the mobile terminal receives a connection request relating to playback of the second content according to the content playing method described in connection with FIG. 32;

FIG. 34 illustrates an example of playing the second content according to the content playing method described in connection with FIG. 32;

FIG. 35 illustrates an example of playing the second content according to the content playing method described in connection with FIG. 32;

FIG. 36 illustrates an example of playing the second content according to the content playing method described in connection with FIG. 32;

FIG. 37 is a flowchart illustrating a content playing method performed by the mobile terminal according to an embodiment of this document;

FIG. 38 illustrates an example where the mobile terminal receives a connection request relating to playback of the second content according to the content playing method described in connection with FIG. 37;

FIG. 39 illustrates an example of playing the second content according to the content playing method described in connection with FIG. 37;

FIG. 40 illustrates an example of playing the second content according to the content playing method described in connection with FIG. 37;

FIG. 41 illustrates an example of playing the second content according to the content playing method described in connection with FIG. 37;

FIGS. 42 and 43 illustrates examples where the mobile terminal displays a control area to control playback of content based on a handwriting input received through the display, which is implemented as a touch screen;

FIGS. 44 and 45 illustrate examples where the mobile terminal displays a control area to control playback of content based on a location and direction of a touch received through the display that is implemented as a touch screen;

FIG. 46 illustrates a process where a control area is displayed on the touch screen for content corresponding to a content identifier when the content identifier is selected from the touch screen of the mobile terminal in response to a touch received through the touch screen;

FIG. 47 illustrates a process where a control area is displayed on the touch screen for content corresponding to an identifier for an electronic device when the identifier is selected from the touch screen of the mobile terminal in response to a touch received through the touch screen; and

FIGS. 48 and 49 illustrate examples where the mobile terminal functions as a remote controller that may control playback of content by other electronic devices.

### DESCRIPTION OF THE EMBODIMENTS

This document will now be described more fully with reference to the accompanying drawings, in which exemplary embodiments of this document are shown. This document may, however, be embodied in many different forms and should not be construed as being limited to the embodiments set forth herein; rather, there embodiments are provided so that this disclosure will be thorough and complete, and will fully convey the concept of this document to those skilled in the art.

Hereinafter, a mobile terminal relating to this document will be described below in more detail with reference to the accompanying drawings. In the following description, suffixes “module” and “unit” are given to components of the mobile terminal in consideration of only facilitation of description and do not have meanings or functions discriminated from each other.

The mobile terminal described in the specification can include a cellular phone, a smart phone, a laptop computer, a digital broadcasting terminal, personal digital assistants (PDA), a portable multimedia player (PMP), a navigation system and so on.

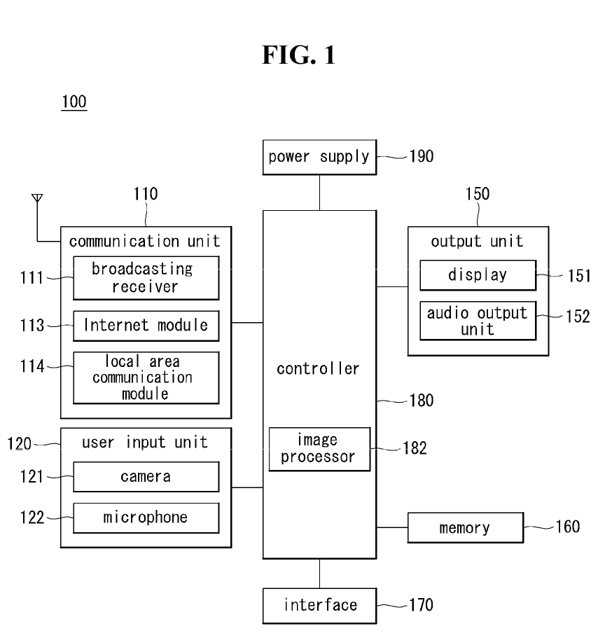

FIG. 1 is a block diagram of an electronic device relating to an embodiment of this document.

As shown, the electronic device 100 may include a communication unit 110, a user input unit 120, an output unit 150, a memory 160, an interface 170, a controller 180, and a power supply 190. Not all of the components shown in FIG. 1 may be essential parts and the number of components included in the electronic device 100 may be varied.

The communication unit 110 may include at least one module that enables communication between the electronic device 100 and a communication system or between the electronic device 100 and another device. For example, the communication unit 110 may include a broadcasting receiving module 111, an Internet module 113, and a local area communication module 114.

The broadcasting receiving module 111 may receive broadcasting signals and/or broadcasting related information from an external broadcasting management server through a broadcasting channel.

The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal. The broadcasting signals may include not only TV broadcasting signals, radio broadcasting signals, and data broadcasting signals but also signals in the form of a combination of a TV broadcasting signal and a radio broadcasting signal of a data broadcasting signal.

The broadcasting related information may be information on a broadcasting channel, a broadcasting program or a broadcasting service provider, and may be provided even through a communication network.

The broadcasting related information may exist in various forms. For example, the broadcasting related information may exist in the form of an electronic program guide (EPG) of a digital multimedia broadcasting (DMB) system or in the form of an electronic service guide (ESG) of a digital video broadcast-handheld (DVB-H) system.

The broadcasting receiving module 111 may receive broadcasting signals using various broadcasting systems. The broadcasting signals and/or broadcasting related information received through the broadcasting receiving module 111 may be stored in the memory 160.

The Internet module 113 may correspond to a module for Internet access and may be included in the electronic device 100 or may be externally attached to the electronic device 100.

The local area communication module 114 may correspond to a module for near field communication. Further, Bluetooth, radio frequency identification (RFID), infrared data association (IrDA), ultra wideband (UWB) and/or ZigBee may be used as a near field communication technique.

The user input 120 is used to input an audio signal or a video signal and may include a camera 121 and a microphone 122.

The camera 121 may process image frames of still images or moving images obtained by an image sensor in a video telephony mode or a photographing mode. The processed image frames may be displayed on a display 151. The camera 121 may be a 2D or 3D camera. In addition, the camera 121 may be configured in the form of a single 2D or 3D camera or in the form of a combination of the 2D and 3D cameras.

The image frames processed by the camera 121 may be stored in the memory 160 or may be transmitted to an external device through the communication unit 110. The electronic device 100 may include at least two cameras 121.

The microphone 122 may receive an external audio signal in a call mode, a recording mode or a speech recognition mode and process the received audio signal into electric audio data. The microphone 122 may employ various noise removal algorithms for removing or reducing noise generated when the external audio signal is received.

The output unit 150 may include the display 151 and an audio output module 152.

The display 151 may display information processed by the electronic device 100. The display 151 may display a user interface (UI) or a graphic user interface (GUI) relating to the electronic device 100. In addition, the display 151 may include at least one of a liquid crystal display, a thin film transistor liquid crystal display, an organic light-emitting diode display, a flexible display and a three-dimensional display. Some of these displays may be of a transparent type or a light transmissive type. That is, the display 151 may include a transparent display. The transparent display may include a transparent liquid crystal display. The rear structure of the display 151 may also be of a light transmissive type. Accordingly, a user may see an object located behind the body of terminal through the transparent area of the terminal body, occupied by the display 151.

The electronic device 100 may include at least two displays 151. For example, the electronic device 100 may include a plurality of displays 151 that are arranged on a single face at a predetermined distance or integrated displays. The plurality of displays 151 may also be arranged on different sides.

Further, when the display 151 and a sensor sensing touch (hereafter referred to as a touch sensor) form a layered structure that is referred to as a touch screen, the display 151 may be used as an input device in addition to an output device. The touch sensor may be in the form of a touch film, a touch sheet, and a touch pad, for example.

The touch sensor may convert a variation in pressure applied to a specific portion of the display 151 or a variation in capacitance generated at a specific portion of the display 151 into an electric input signal. The touch sensor may sense pressure of touch as well as position and area of the touch.

When the user applies a touch input to the touch sensor, a signal corresponding to the touch input may be transmitted to a touch controller. The touch controller may then process the signal and transmit data corresponding to the processed signal to the controller 180. Accordingly, the controller 180 can detect a touched portion of the display 151.

The audio output module 152 may output audio data received from the communication unit 110 or stored in the memory 160. The audio output module 152 may output audio signals related to functions, such as a call signal incoming tone and a message incoming tone, performed in the electronic device 100.

The memory 160 may store a program for operation of the controller 180 and temporarily store input/output data such as a phone book, messages, still images, and/or moving images. The memory 160 may also store data about vibrations and sounds in various patterns that are output from when a touch input is applied to the touch screen.

The memory 160 may include at least a flash memory, a hard disk type memory, a multimedia card micro type memory, a card type memory, such as SD or XD memory, a random access memory (RAM), a static RAM (SRAM), a read-only memory (ROM), an electrically erasable programmable ROM (EEPROM), a programmable ROM (PROM) magnetic memory, a magnetic disk or an optical disk. The electronic device 100 may also operate in relation to a web storage performing the storing function of the memory 160 on the Internet.

The interface 170 may serve as a path to all external devices connected to the electronic device 100. The interface 170 may receive data from the external devices or power and transmit the data or power to internal components of the electronic device 100 or transmit data of the electronic device 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The controller 180 may control overall operations of the electronic device 100. For example, the controller 180 may perform control and processing for voice communication. The controller 180 may also include an image processor 182 for pressing image, which will be explained later.

The power supply 190 receives external power and internal power and provides power required for each of the components of the electronic device 100 to operate under the control of the controller 180.

Various embodiments described in this document can be implemented in software, hardware or a computer readable recording medium. According to hardware implementation, embodiments of this document may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and/or electrical units for executing functions. The embodiments may be implemented by the controller 180 in some cases.

According to software implementation, embodiments such as procedures or functions may be implemented with a separate software module executing at least one function or operation. Software codes may be implemented according to a software application written in an appropriate software language. The software codes may be stored in the memory 160 and executed by the controller 180.

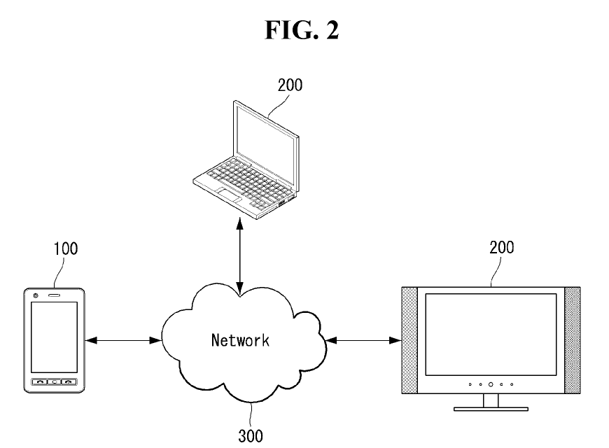

FIG. 2 is a diagram illustrating a structure of a service network according to an embodiment of this document and a structure of a service network for sharing contents between electronic devices.

Referring to FIG. 2, the electronic device 100 is connected to at least one outer electronic device 200 that can perform an image display function through a network, and transmits contents to the outer electronic device 200 in order to display contents in the outer electronic device 200 or receives contents from the outer electronic device 200 and displays the contents on a screen and thus shares the contents with the outer electronic device 200.

FIG. 2 illustrates a case where the electronic device 100 is a mobile phone and the outer electronic device 200 is a television (TV) and a laptop computer, but this document is not limited thereto. According to an embodiment of this document, the mobile terminal 100 and the outer electronic device 200 may be a mobile phone, a TV, a laptop computer, a smart phone, a digital broadcasting terminal, personal digital assistants (PDA), a portable multimedia player (PMP), a navigation device, a desktop computer, a set-top box, a personal video recorder (PVR), and an electronic frame.

Referring again to FIG. 2, in order for the electronic device 100 to share contents with the outer electronic device 200, it is necessary to form a platform of the electronic device 100 and the outer electronic device 200 for mutual compatibility between the electronic device 100 and the outer electronic device 200. For this reason, the electronic devices 100 and 200 according to an embodiment of this document form a platform based on a digital living network alliance (DLNA).

According to the DLNA, IPv4 can be used as a network stack, and for network connection, Ethernet, Wireless Local Network (WLAN) (802.11a/b/g), Wireless Fidelity (Wi-Fi), Bluetooth, and a communication method that can perform IP connection can be used.

Further, according to the DLNA, in order to discover and control an electronic device, a Universal Plug and Play (UPnP), particularly, UPnP AV Architecture and UPnP Device Architecture are generally used. For example, in order to discover an electronic device, a simple service discovery protocol (SSDP) can be used. Further, in order to control an electronic device, a simple object access protocol (SOAP) can be used.

Further, according to the DLNA, in order to transmit media, HTTP and RTP can be used, and JPEG, LPCM, MPEG2, MP3, and MPEG4 can be used as a media format.

Further, according to the DLNA, digital media server (DMS), digital media player (DMP), digital media renderer (DMR), digital media controller (DMC) type electronic devices can be supported.

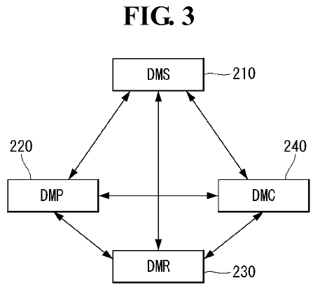

FIG. 3 is a conceptual diagram of a DLNA network.

The DLNA is a network and is a typical name of a standardization device for enabling to mutually share contents such as music, a moving image, and a still image between electronic devices.

The DLNA generally uses an UPnP protocol.

The DLNA network includes a DMS 310, a DMP 320, a DMR 330, and a DMC 340.

The DLNA network includes at least one of each of the DMS 310, the DMP 320, the DMR 330, and the DMC 340. In this case, the DLNA provides a specification for mutual compatibility of the each device. Further, the DLNA network provides a specification for mutual compatibility between the DMS 310, the DMP 320, the DMR 330, and the DMC 340.

The DMS 310 provides digital media contents. That is, the DMS 310 stores and manages contents. The DMS 310 receives and executes various commands from the DMC 340. For example, when the DMS 310 receives a play command, the DMS 310 searches for contents to reproduce and provides the contents to the DMR 330. The DMS 310 may include, for example, a personal computer (PC), a personal video recorder (PVR), and a set-top box.

The DMP 320 controls contents or an electronic device, and controls to contents to be reproduced. That is, the DMP 320 performs a function of the DMR 330 for reproduction and a function of the DMC 340 for control. The DMP 320 may include, for example, a TV, a DTV, and a home theater.

The DMR 330 reproduces contents. The DMR 330 reproduces contents that receive from the DMS 310. The DMR 330 may include, for example, an electronic frame.

The DMC 340 provides a control function. The DMC 340 may include, for example, a mobile phone and a PDA.

Further, the DLNA network may include the DMS 310, the DMR 330, and the DMC 340 or may include the DMP 320 and DMR 330.

Further, the DMS 310, the DMP 320, the DMR 330, and the DMC 340 may be a term of functionally classifying an electronic device. For example, when the mobile phone has a reproduction function as well as a control function, the mobile phone may correspond to the DMP 320, and when the DTV manages contents, the DTV may correspond to the DMS 310 as well as the DMP 320.

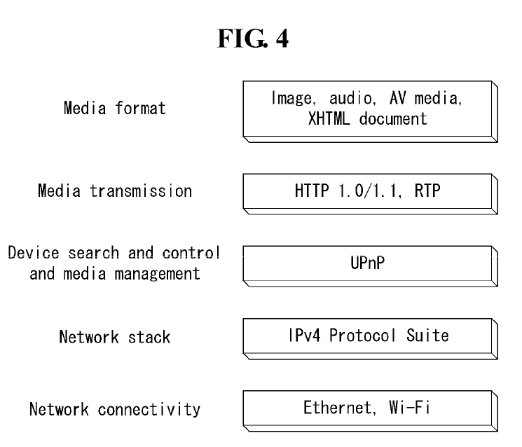

FIG. 4 is a diagram illustrating a function component according to a DLNA.

The function component according to the DLNA includes a media format layer, a media transport layer, a device discovery & control and media management layer, a network stack layer, and a network connectivity layer.

The network connectivity layer includes a physical layer and a link layer of a network. The network connectivity layer includes Ethernet, Wi-Fi, and Bluetooth. In addition, the network connectivity layer uses a communication medium that can perform IP connection.

The network stack layer uses an IPv4 protocol.

The device discovery & control and media management layer generally uses UPnP, particularly, UPnP AV Architecture and UPnP Device Architecture. For example, for device discovery, an SSDP may be used. Further, for control, SOAP may be used.

The media transport layer uses HTTP 1.0/1.1 or a real-time transport protocol (RTP) in order to reproduce streaming.

The media format layer uses an image, audio, AV media, and extensible hypertext markup language (XHTML) document.

Hereinafter, various embodiments will be described wherein the electronic device is a mobile terminal that may control playback of first content while simultaneously controlling playback of second content when receiving a connection request relating to playback of the first content from another electronic device or while controlling playback of the second content. As used herein, the network formed between the mobile terminal and other electronic devices may include a DLNA network described above. However, the embodiments of this document are not limited thereto.

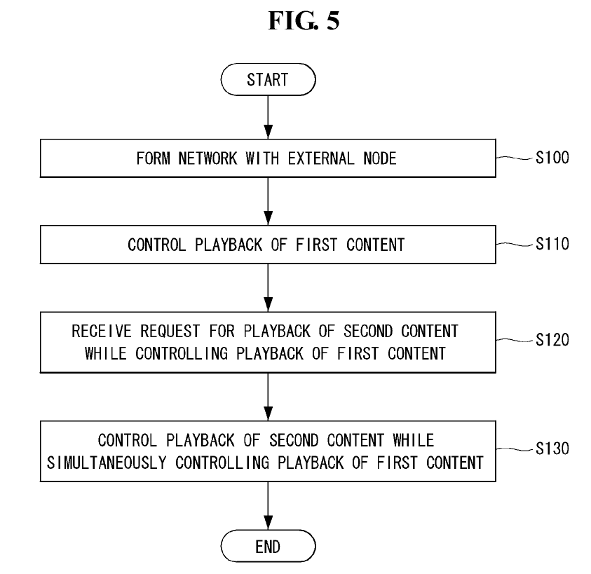

FIG. 5 is a flowchart illustrating a method of controlling playback of content by the mobile terminal 100 according to an embodiment of this document.

First, the mobile terminal 100 and an external node form a network (S100). According to an embodiment, the external node may include, but not limited to, a mobile phone, a smart phone, or a tablet PC, such as the mobile terminal 100, or a stationary electronic device, such as a PC or TV.

Then, the mobile terminal 100 controls playback of first content (S110). According to an embodiment, the mobile terminal 100 may control playback of the first content while directly playing the first content.

According to an embodiment, the first content may be stored in the mobile terminal 100 or may be received from a first electronic device and played by the mobile terminal 100. According to an embodiment, the first content may be played by the first electronic device, and the mobile terminal 100 may control the first electronic device. According to an embodiment, the first content may be transmitted from the mobile terminal 100 to the first electronic device or may be stored in the first electronic device. Alternatively, the first content may be transmitted from a second electronic device to the first electronic device. According to an embodiment, the mobile terminal 100 may control both the first and second electronic devices.

When receiving a request for playing first content while controlling playback of the first content (S120), the mobile terminal 100 controls playback of the first content while simultaneously controlling playback of the first content (S130).

According to an embodiment, the request for playing the first content may be made by a user through an input device of the mobile terminal 100. According to an embodiment, the first content may be content stored in the mobile terminal 100 or content stored in the first electronic device.

According to an embodiment, the request for playing the first content may be received from the first electronic device. According to an embodiment, the first content may be content stored in the mobile terminal 100, the first electronic device, or the second electronic device.

According to an embodiment, the request for playing the first content may include a request for direct playback of the first content or a connection request related to playback of the first content.

For example, according to an embodiment, the request for playing the first content may include the first electronic device requesting that the mobile terminal 100 or the second electronic device receive and play the first content stored in the first electronic device. According to an embodiment, the request for playing the first content may include requesting that content stored in the mobile terminal 100 be transmitted to the second electronic device and played by the second electronic device.

According to an embodiment, the request for playing the first content may include requesting that the mobile terminal 100 receive and play the first content stored in the second electronic device. However, the embodiments of this document are not limited thereto, and various modifications may be made within the scope of claims.

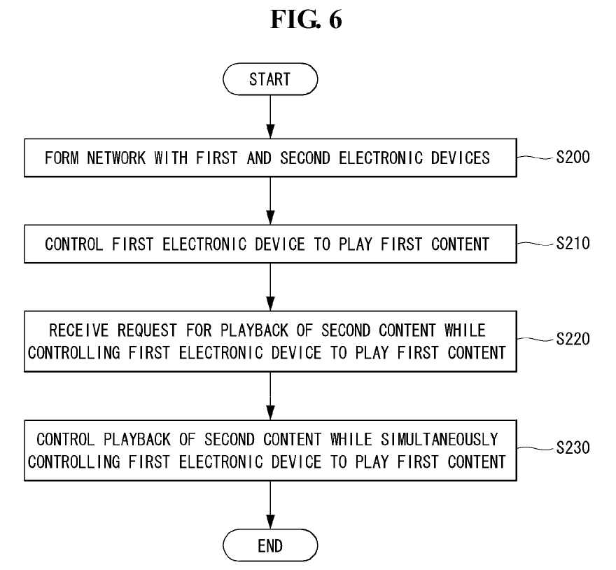

FIG. 6 is a flowchart illustrating a method of playing content by the mobile terminal 100 according to an embodiment of this document.

First, the mobile terminal 100, the first electronic device, and the second electronic device form a network (S200). Then, the mobile terminal 100 controls the first electronic device to play first content (S210). According to an embodiment, the first content may be content stored in the mobile terminal 100 or other electronic devices, such as the first and second electronic devices.

While controlling the first electronic device so that the first electronic device plays the first content, the mobile terminal 100 receives a request for playing second content from the second electronic device (S220). Then, the mobile terminal 100 controls playback of the second content while simultaneously controlling the first electronic device for playback of the first content (S230).

According to an embodiment, the mobile terminal 100 may directly play the second content or may control another electronic device connected to the network so that the other electronic device plays the second content.

Hereinafter, the content playing method described in connection with FIG. 6 will be described in more detail.

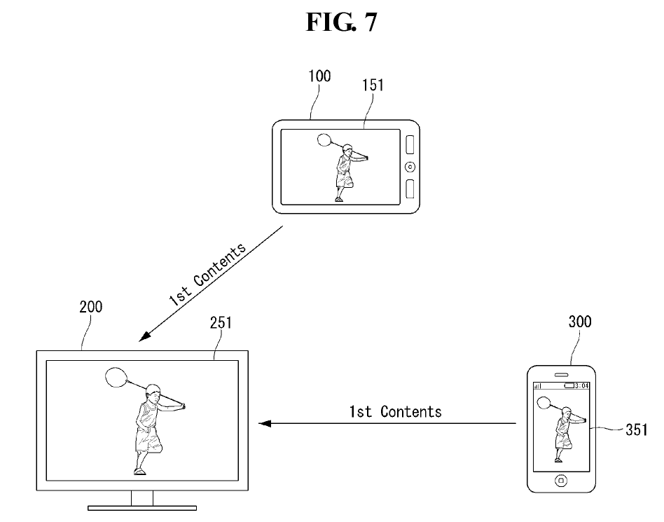

FIG. 7 illustrates a process of transmitting the first content to the first electronic device 200 in the content playing method described in connection with FIG. 6. Referring to FIG. 7, the first content may be transmitted to the first electronic device 200 from the mobile terminal 100 and may be played by the mobile terminal 100. The first content may be transmitted from the second electronic device 300 to the first electronic device 200. According to an embodiment, while simultaneously displayed on the display 251 of the first electronic device 200, the first content may be transmitted from the mobile terminal 100 or the second electronic device 300 and may be displayed on the display 151 of the mobile terminal 100 or on the display 351 of the second electronic device 300

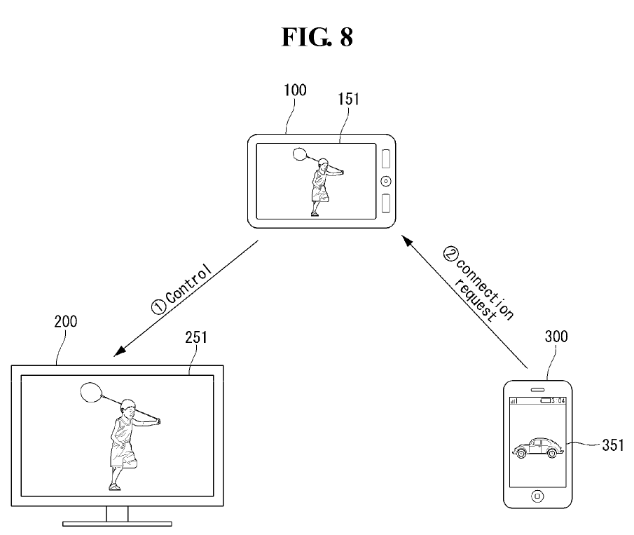

FIG. 8 illustrates an example where in the content playing method described in connection with FIG. 6, the second electronic device 300 transmits a connection request relating to playback of the second content to the mobile terminal 100. Referring to FIG. 8, the mobile terminal 100 receives a connection request relating to playback of the second content from the second electronic device 300 while controlling the first electronic device 200 to play the first content.

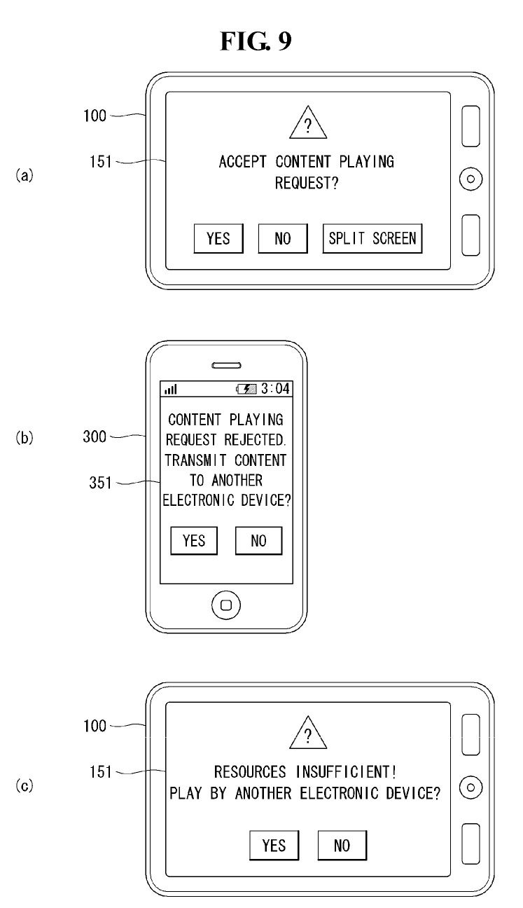

FIG. 9 illustrates an example where in the content playing method described in connection with FIG. 6, the mobile terminal 100 makes a response to the received connection request relating to playback of the second content.

Referring to (a) of FIG. 9, the controller 180 of the mobile terminal 100 outputs an inquiry on whether to accept a received second content playing connection request on the display 151.

Under the situation shown in (a) of FIG. 9, a user may select “YES” to accept the request, may select “NO” to reject the request, or may select “SPLIT SCREEN” to display the second content and the image being currently displayed on the display 151 at the same time. According to an embodiment, the display 151 may be configured as a touch screen, so that the selection can be made by touching the corresponding area on the display 151.

Referring to (b) of FIG. 9, the mobile terminal 100 rejects the request for playing the second content from the second electronic device 300, and thus, a message is displayed that is transmitted to the second electronic device 300. Specifically, as shown in (b) of FIG. 9, if the mobile terminal 100 rejects the second content playing request, the mobile terminal 100 transmits a message to the second electronic device 300 to inquire whether to transfer the second content to another electronic device for playback of the second content.

If the message is received by the second electronic device 300 and displayed on the display 351 of the second electronic device 300, the user of the second electronic device 300 may select “YES” so that the second content may be played by the other electronic device or may select “NO” to terminate the request for playing the second content.

(c) of FIG. 9 illustrates an example where the mobile terminal 100 having received the request for playing the second content displays some message on the display 151 when resources are insufficient to play the second content.

Referring to (c) of FIG. 9, the message represents that the mobile terminal 100 falls short of the resource to play the second content and that the second content may be played by another electronic device. The user of the mobile terminal 100 may select “YES” so that the other electronic device may play the second content or may select “NO” to abandon playback of the second content.

Hereinafter, examples will be described where the mobile terminal 100 controls playback of the second content when receiving a connection request relating to playback of the second content from the second electronic device 300 while the first electronic device 200 plays the first content.

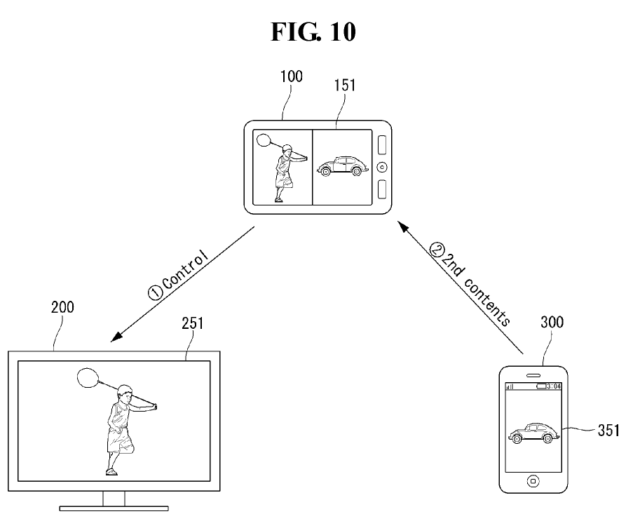

FIG. 10 illustrates an example of playing the second content according to the content playing method described in connection with FIG. 6. Referring to FIG. 10, the mobile terminal 100 receives the second content from the second electronic device 300 and plays the second content on the display 151 while controlling the first electronic device 200 so that the first electronic device 200 plays the first content.

As shown in FIG. 10, the mobile terminal 100 outputs both the first content and second content on the display 151. However, the embodiments of this document are not limited thereto. For example, according to an embodiment, the mobile terminal 100 may display only the second content on the display 151.

When receiving a request for playing the second content, the mobile terminal 100 may display an area on the display 151 so that an electronic device may be selected to play the second content among at least one electronic device connected to the network.

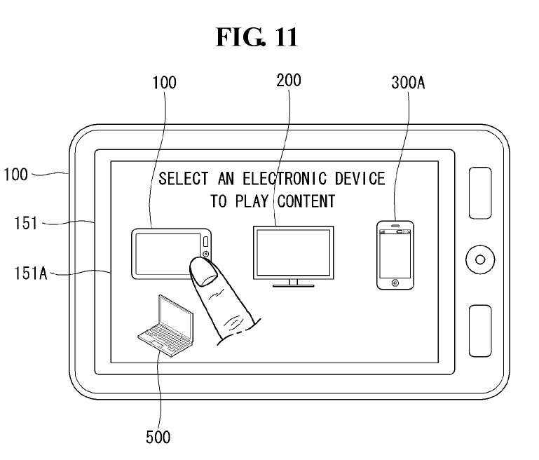

FIG. 11 illustrates an example where a selection area 151A is displayed on the display 151 of the mobile terminal 100 so that an electronic device may be selected to play the second content. Referring to FIG. 11, the selection area 151A displays the mobile terminal 100, a TV 200, a mobile terminal 300A, and a laptop computer 500 that may play the second content. As shown in FIG. 11, the user selects the mobile terminal 100 as an electronic device to play the second content among the electronic devices displayed on the selection area 151A.

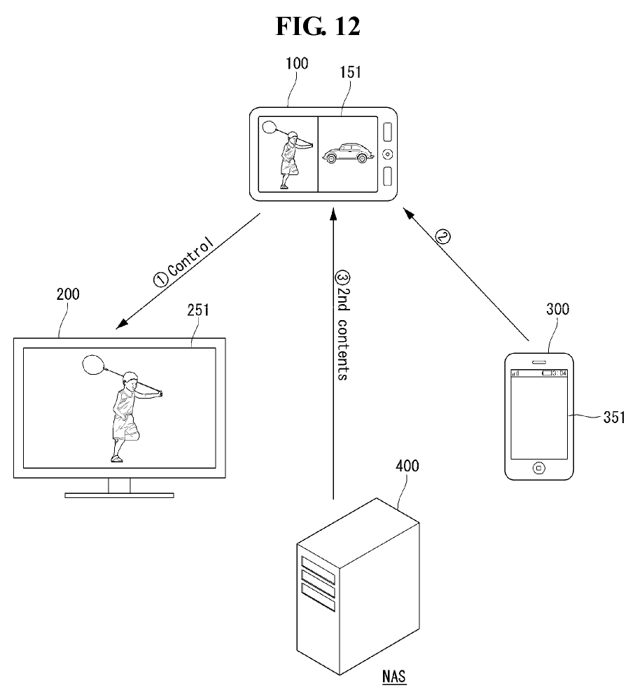

FIG. 12 illustrates an example where the second content is played according to the content playing method described in connection with FIG. 6. Referring to FIG. 12, the mobile terminal 100 receives the second content from not the second electronic device 300 but the third electronic device 400 and displays the second content on the display 151 while controlling the first electronic device 200 so that the first electronic device 200 plays the first content.

According to an embodiment, the third electronic device 400 may include a NAS (Network Attached Storage) as shown in FIG. 12. The NAS refers to a data storage connected to a network so that a huge amount of data or files stored therein may be easily accessed from various places, such as offices or home.

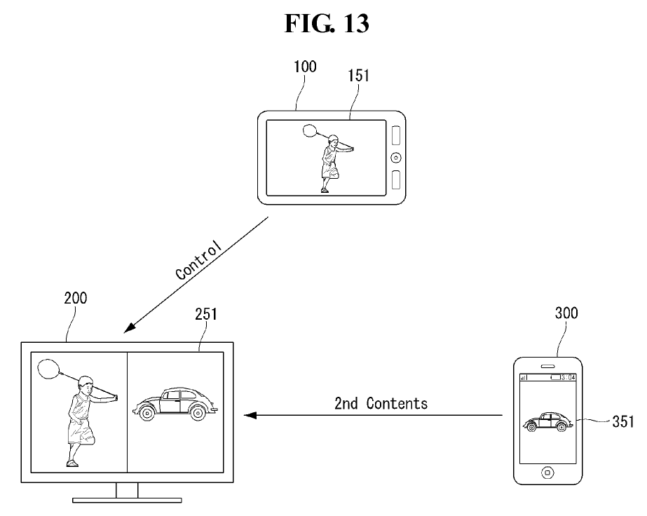

FIG. 13 illustrates an example where the second content is played according to the content playing method described in connection with FIG. 6. Referring to FIG. 13, the mobile terminal 100 enables the first electronic device 200 to receive the second content from the second electronic device 300 and to play the second content while controlling the first electronic device 200 so that the first electronic device 200 plays the first content.

For the second content to be displayed by another electronic device although the request for playing the second request has been received, the mobile terminal 100 displays on the display 151 of the mobile terminal 100 a selection area for selecting an electronic device to play the second content among at least an electronic device connected to the network.

An example where the mobile terminal 100 renders the second content to be played by the other electronic device includes, but not limited to, a case where the playback of the second content is rejected by a user's selection as shown in (a) of FIG. 9 and a case where the playback of the second content is automatically rejected due to lack of available resources of the mobile terminal 100.

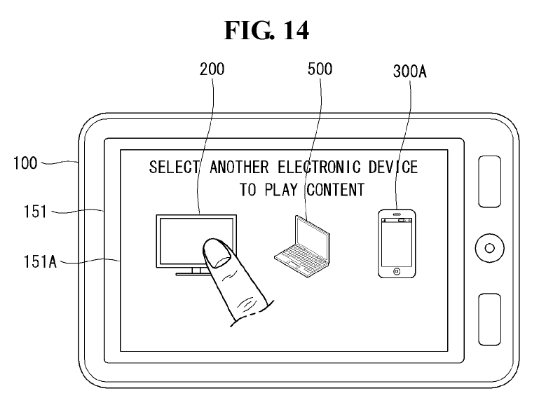

FIG. 14 illustrates an example where a selection area 151A is displayed on the display 151 of the mobile terminal 100 to select an electronic device that may play the second content. Referring to FIG. 14, a TV 200, a mobile 300A, and a laptop computer 500 are displayed on the selection area 151A as electronic devices that may play the second content.

FIG. 13 illustrates an example where among the electronic devices displayed on the selection area 151A as shown in FIG. 14, the TV 200 is selected as an electronic device to play the second content. For example, the second content may be played by the TV 200 by selection of the user of the mobile terminal 100. According to an embodiment, the selection area 151A may be displayed on the 100 for selecting an electronic device to play the second content when the mobile terminal 100 rejects the request for playing the second content.

For the second content to be played by another electronic device although the request for playing the second content, the mobile terminal 100 transmits information on an electronic device connected to the network, which may play the second content, to the second electronic device 300 that made the request.

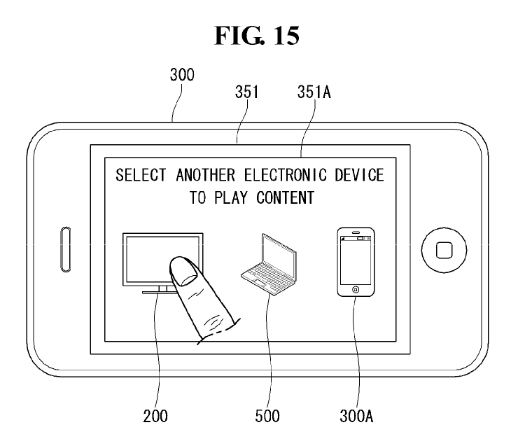

FIG. 15 illustrates an example where a selection area 351A is displayed on the display 151 of the mobile terminal 100 to select an electronic device for playing the second content based on information on other electronic devices received from the mobile terminal 100, which may play the second content

Referring to FIG. 15, a TV 200, a mobile terminal 300A, and a laptop computer 500 are displayed on the selection area 251A as electronic devices that may play the second content. As shown in FIG. 15, FIG. 13 illustrates an example where a user selects the TV 200 as an electronic device to play the second content among the electronic devices displayed on the selection area 351A. For example, the second content may be played by the TV 200 by selection of a user of the second electronic device 300.

Unlike that shown in FIG. 15, according to an embodiment, the mobile terminal 100 may transmit a message rejecting the playback of the second content to the second electronic device 300 as shown in (b) of FIG. 9 instead of transmitting the information on the electronic devices that may play the second content.

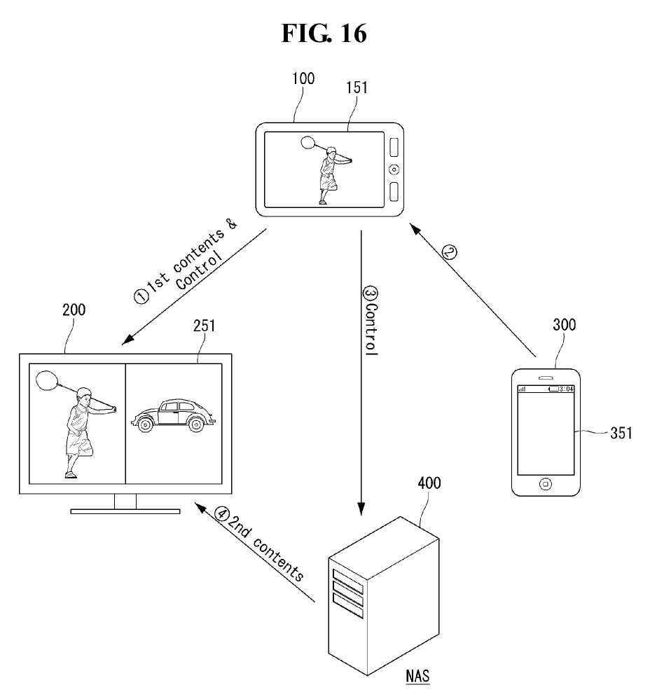

FIG. 16 illustrates an example of playing the second content according to the content playing method described in connection with FIG. 6. Referring to FIG. 16, when the second electronic device 300 requests that the mobile terminal 100 play the second content stored in a separate storage, for example, the NAS 400, the mobile terminal 100 controls the playback of the second content.

Referring to FIG. 16, when receiving a request for playing the second content from the second electronic device 300, the mobile terminal 100 controls the NAS 400 so that the second content is transmitted to the first electronic device 200 and controls the first electronic device 200 so that the first electronic device 200 plays the second content. The mobile terminal 100 may also control the first electronic device 200 so that the first electronic device 200 plays the first content.

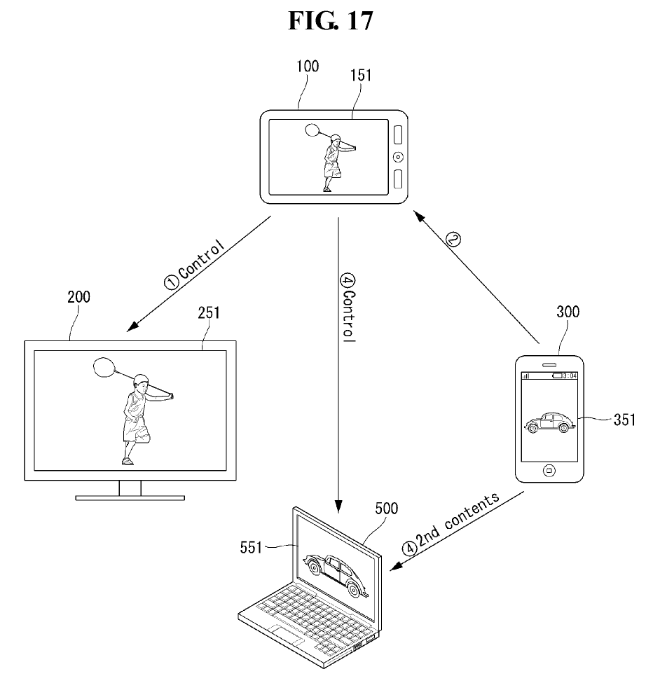

FIG. 17 illustrates an example where the second content is played according to the content playing method described in connection with FIG. 6. Referring to FIG. 17, when receiving a request for playing the second content from the second electronic device 300 while controlling the first electronic device 200 so that the first electronic device 200 plays the first content, the mobile terminal 100 controls the second electronic device 300 so that the second content is transmitted to an electronic device 500 and controls the electronic device 500 so that the electronic device receives and plays the second content. The mobile terminal 100 continues to control the first electronic device 200.

As described above with reference to FIGS. 13 to 17, the mobile terminal 100 may control the first electronic device 200 to play the first content while simultaneously controlling at least one electronic device connected to the network so that the first electronic device 200 receives the second content through the network and plays the second content when receiving a connection request relating to playback of the second content from the second electronic device 300 while controlling the first electronic device 200 to play the first content.

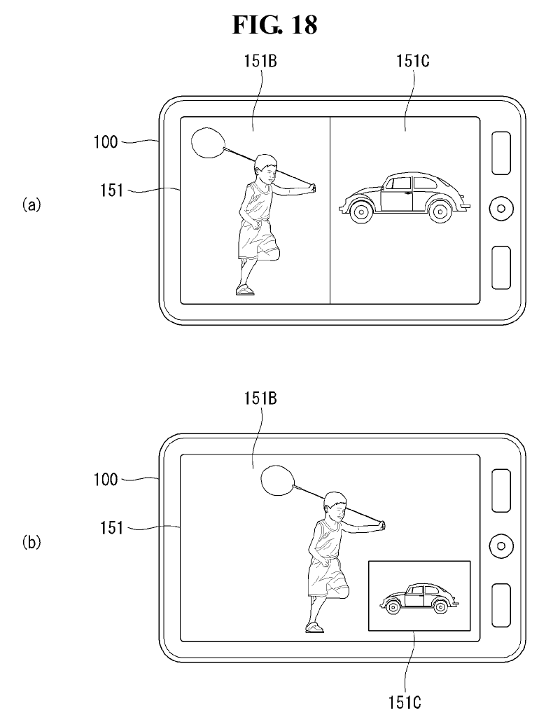

FIG. 18 illustrates an example where the mobile terminal 100 plays first and second contents according to the content playing method described in connection with FIG. 6. Referring to FIG. 18, when receiving a connection request relating to playback of the second content from the second electronic device 300 while controlling the first electronic device 200 to play the first content, the mobile terminal 100 displays the first content on a first display area 151B of the display 151 and the second content on a second display area 151C of the display 151. According to embodiments, the first and second display areas 151B and 151C may be separated from each other or may overlap each other.

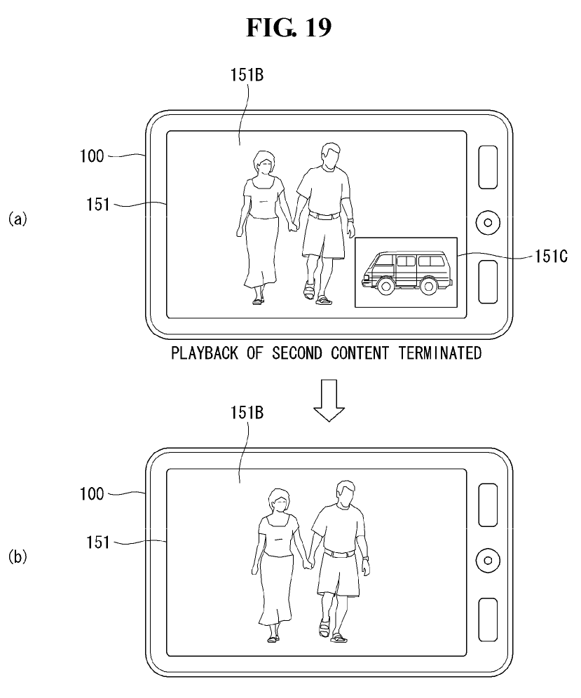

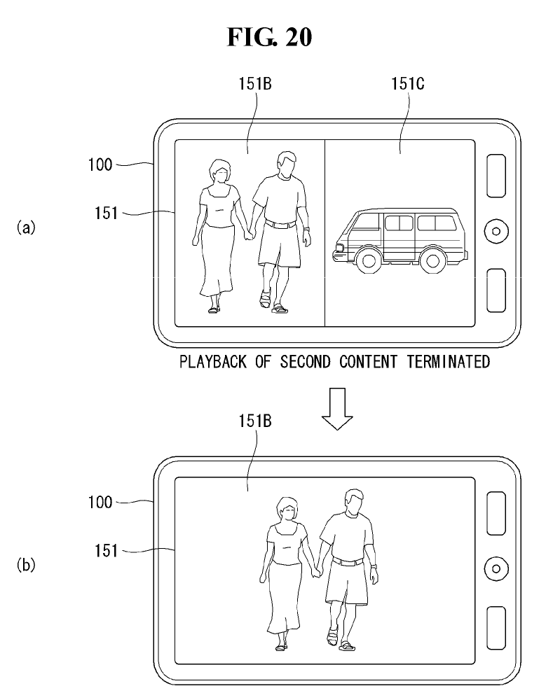

FIGS. 19 and 20 illustrate an example where the content playing area of the mobile terminal 100 changes as the playback of content by the mobile terminal 100 terminates according to the content playing method described in connection with FIG. 6. Referring to FIGS. 19 and 20, while the first and second contents are played, the first display area 151B displays the first content and the second display area 151C displays the second content. However, when the playback of the second content ends, the second display area 151B changes to the first display area 151B to display the first content.

For example, if playback of one of the first and second contents is terminated while the first and second contents are played on the display 151, then the mobile terminal 100 enables the non-terminated content to be displayed on the entire screen of the display 151.

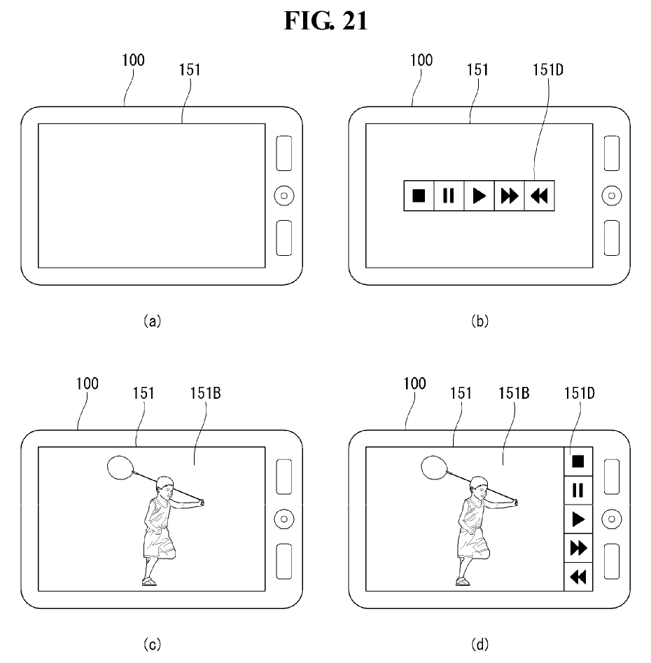

FIG. 21 illustrates various screens displayed on the display 151 of the mobile terminal 100 while controlling playback of the first content.

(a) of FIG. 21 illustrates an example where in the case that a predetermined time elapses without an entry of a control signal while controlling the first electronic device 200 to play the first content, the mobile terminal 100 enters into a power saving mode to block output of an image to the display 151. When a control signal is generated by a user's manipulation under the situation shown in (a) of FIG. 21, the controller 180 of the mobile terminal 100 outputs a predetermined image on the display 151.

Although it has been illustrated in (a) of FIG. 21 that no image is output on the display 151, the embodiments of this document are not limited thereto. For example, according to an embodiment, the mobile terminal 100 may display a predetermined image for screen protection in the power saving mode.

(b) of FIG. 21 illustrates an example where a control area 151D shows up on the display 151 of the mobile terminal 100 to control the first electronic device 200 so that the first content is played. If a predetermined time goes by without an input of a control signal under the state shown in (b) of FIG. 21, the display 151 may turn to the screen shown in (a) of FIG. 1.

(c) of FIG. 21 illustrates an example where the first content, which is played by the first electronic device 200, is displayed on the display 151 of the mobile terminal 100. If a predetermined time goes by without an input of a control signal under the state shown in (c) of FIG. 21, the display 151 may change to display the screen shown in (a) of FIG. 21.

(d) of FIG. 21 illustrates an example where a control area 151D is displayed together with the first content on the display 151 of the mobile terminal 100 to play the first electronic device 200 so that the first content is played. The elapse of a predetermined time without an input of a control signal renders the display 151 to display the screen shown in (a) of FIG. 21 or (b) of FIG. 20.

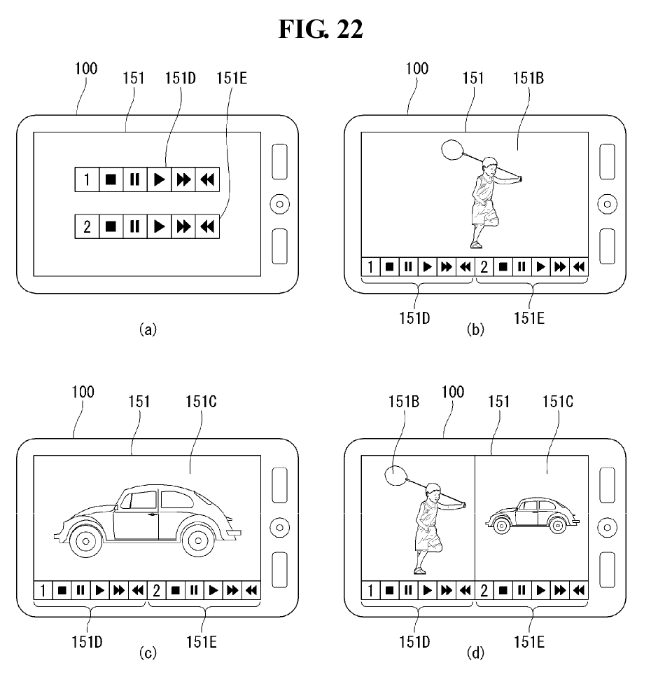

FIG. 22 illustrates various screens displayed on the display 151 of the mobile terminal 100 while controlling playback of the first content. Specifically, FIG. 22 shows display states of the display 151 when controlling playback of the second content while controlling the first electronic device 200 so that the first content is played.

Referring to (a) of FIG. 22, a first control area 151D and a second control area 151E are displayed on the display 151 of the mobile terminal 100 to control playback of the first and second contents, respectively. If a predetermined time elapses without an input of a control signal, the display 151 changes to the screen shown in (a) of FIG. 20, which represents a power saving mode.

Referring to (b) of FIG. 22, the mobile terminal 100 displays on the display 151 the first content and the first and second control areas 151D and 151E for control of playback of the first and second contents, respectively. If a predetermined time goes by without an input of a control signal, the screen of the display 151 shifts to the screen shown in (a) of FIG. 20 representing the power saving mode or to the screen shown in (a) of FIG. 22.

Referring to (c) of FIG. 22, the mobile terminal 100 displays on the display 151 the second content and the first and second control areas 151D and 151E for controlling playback of the first and second contents, respectively. If a predetermined time elapses without an input of a control signal, the mobile terminal 100 displays the second content alone or the second content and second content area 151E on the display 151.

Or, the screen of the display 151 changes to the screen shown in (a) of FIG. 20 representing the power saving mode or the screen shown in (a) of FIG. 22.

Referring to (d) of FIG. 22, the mobile terminal 100 displays on the display 151 the first and second control areas 151D and 151E for control of playback of the first and second contents, respectively, as well as the first and second contents. The elapse of a predetermined time without an input of a control signal enables the mobile terminal 100 to display only the first and second contents on the display 151 or to display only the first and second contents and the second control area 151E on the display 151.

Further, upon passage of the predetermined time with no control signal input, the screen of the display 151 shifts to the power saving mode as shown in (a) of FIG. 20 or to one of the screens as shown in (a) to (c) of FIG. 22.

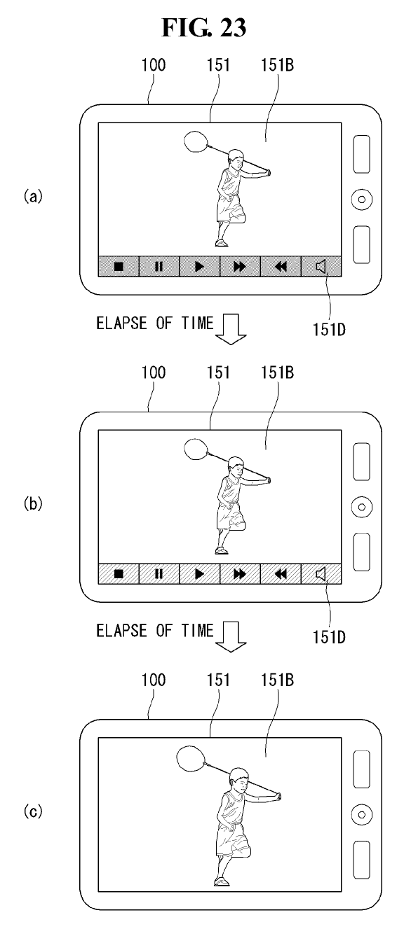

FIG. 23 illustrates an example where transparency of the control area 151D displayed on the display 151 of the mobile terminal 100 varies with time. As used in connection with FIGS. 23 to 25, the “elapse of time” refers to a situation where time elapses without an input of a control signal.

Referring to FIG. 23, as times go by, the transparency of the control area 151D displayed on the display 151 increases. After a predetermined time, the control area 151D completely becomes transparent and is not thus displayed on the display 151. According to an embodiment, the degree of variation in transparency of the control area 151D over time may be predetermined and stored in the memory 160. According to an embodiment, the degree of variation in transparency may be arbitrarily changed by a user.

Although the control area 151D for controlling the first content has been exemplified for the description in connection with FIG. 23, the description may also apply to a control area for controlling the second content in the same or substantially the same manner. For example, according to an embodiment, the mobile terminal 100 may display a control area for controlling at least one of the first and second contents on the display 151 and may vary the transparency of the control area.

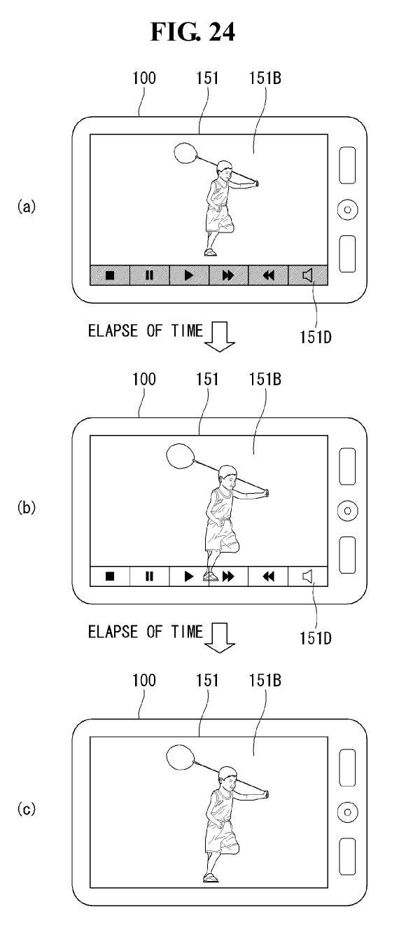

FIG. 24 illustrates an example where a content displaying area 151B expands depending on variation of the transparency of the control area 151D displayed on the display 151 of the mobile terminal 100. Referring to FIG. 24, the transparency of the control area 151D increases as times go by. If the transparency off the control area 151D arrives at a predetermined degree of transparency, the content displaying area 151B expands to the control area 151D.

According to an embodiment, the transparency of the display 151D by which the content displaying area 151B overlaps the control area 151D may be predetermined. According to an embodiment, the predetermined transparency of the control area 151D may be changed at a user's discretion.

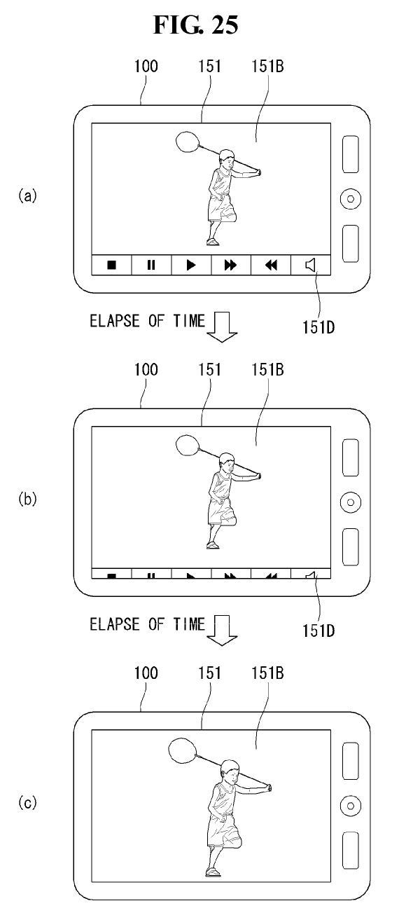

FIG. 25 illustrates an example where the control area 151D displayed on the display 151 of the mobile terminal 100 varies with time. Referring to FIG. 25, as times go by without an input of a control signal with the control area 151D displayed on the display 151, the control area 151D gradually decreases and ends up disappearing from the screen.

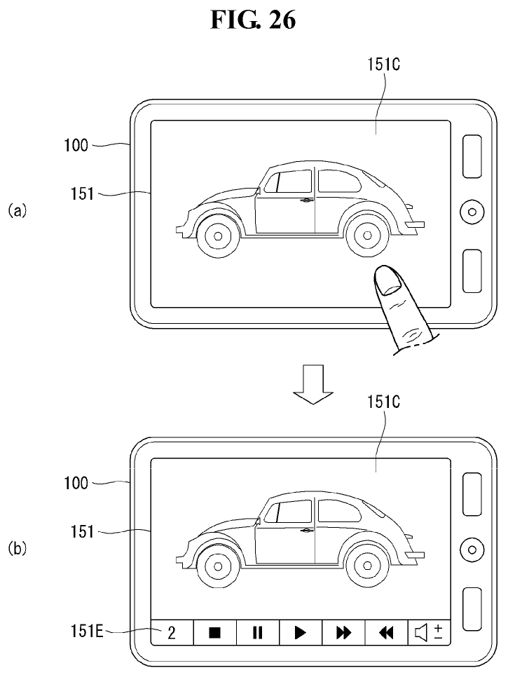

FIGS. 26 to 28 illustrate an exemplary process of displaying a control area for controlling playback of content by the mobile terminal 100 based on the location of a touch to the display 151 that is implemented as a touch screen.

Referring to FIG. 26, when a user touches a displaying area 151C of the second content, a control area 151E is displayed on the display 151 to control playback of the second content.

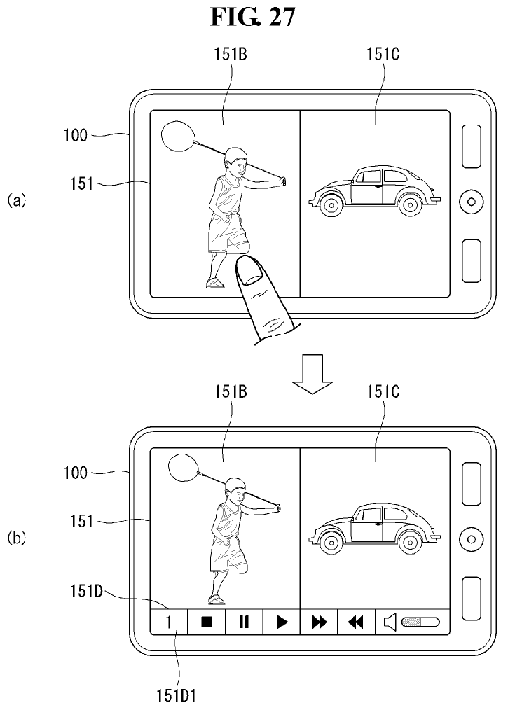

Referring to FIG. 27, if the user touches the playing area 151B of the first content with the first and second contents displayed on the display 151, the control area 151D is displayed on the display 151 to control playback of the first content. The control area 151D includes an index displaying area 151D1 representing that the control area 151D is an area for controlling playback of the first content.

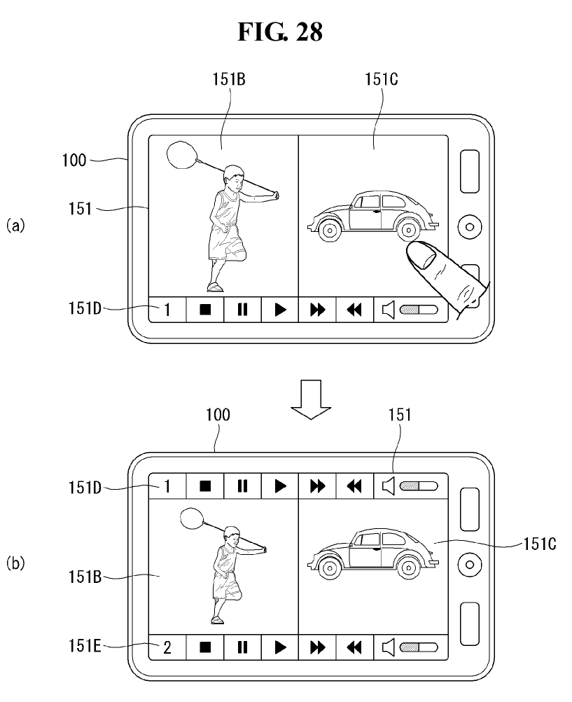

Referring to FIG. 28, if the user touches the playing area 151C of the second content while the control area 151D for controlling playback of the first content is displayed on the control area 151 along with the first and second contents, a control area 151E for controlling playback of the second content is displayed on the display 151.

As described above with reference to FIGS. 26 to 28, the mobile terminal 100 may display a control area for controlling playback of content on the touch screen based on a touch to the touch screen that displays the content, and the content whose playback is controlled by the control area may be determined based on the location of the touch on the touch screen.

The process of displaying the control area for controlling playback of the content based on the location of a user's touch as described in connection with FIGS. 26 to 28 is merely an example, and the embodiments of this document are not limited thereto.

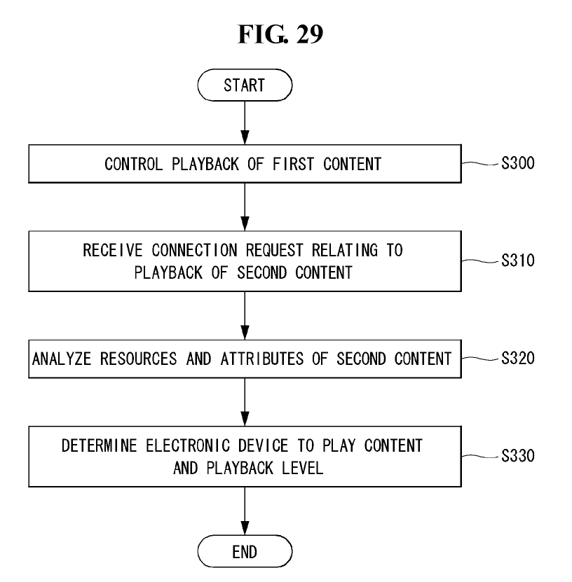

FIG. 29 is a flowchart illustrating a content playing method performed by the mobile terminal 100 according to an embodiment of this document.

While controlling playback of the first content by the first electronic device 200, the mobile terminal 100 receives a connection request relating to playback of the second content (S310).

Then, the mobile terminal 100 analyzes resources of the mobile terminal 100 and attributes of the second content (S320). As used herein, the resources of the mobile terminal 100 collectively refer to all functions and mechanisms for operating various programs in the mobile terminal 100. For example, according to an embodiment, the resources of the mobile terminal 100 may include hardware resources of the controller 180, the communication unit 110, the user input unit 120, and the output unit 150, and software resources of data, files, and programs.

According to an embodiment, the attributes (or attribute information) of the second content may include the type of the second content (for example, music files, movie files, or text files), the size of the second content, or the resolution of the second content that is a movie file. However, the embodiments of this document are not limited thereto.

Upon completion of the resources of the mobile terminal 100 and analysis of the second content, the mobile terminal 100 selects an electronic device to play the second content or determines a playback level of the second content based on the analysis result (S330). Examples of controlling playback of the second content based on the analysis result by the mobile terminal 100 will now be described.

According to an embodiment, in the case that resources for playing the second content are insufficient, the mobile terminal 100 may control the second electronic device 300 and another electronic device connected to the network so that the second content may be played by the other electronic device. For example, according to an embodiment, if the second content is a file whose playback is not supported by the mobile terminal 100, the mobile terminal 100 may control the second electronic device 300 and the other electronic device so that the second content may be played by the other electronic device.

According to an embodiment, the mobile terminal 100 may select an electronic device to play the second content based on the type of the second content. For example, according to an embodiment, if the second content is a music file, the mobile terminal 100 may control the second electronic device 300 and a speaker connected to the network so that the music file may be played by the speaker.

According to an embodiment, the mobile terminal 100 may select different electronic devices to play the second content depending on the type of signal included in the second content. For example, according to an embodiment, if the second content is a movie file containing an image signal and a sound signal, the mobile terminal 100 may enable the image signal to be played by a TV connected to the network and the sound signal to be played by a speaker connected to the network.

According to an embodiment, the second content may be split into the image signal and the sound signal and may be transmitted to the TV and the speaker. Or, according to an embodiment, the second content may be transmitted to the TV and the speaker without being split to the image and sound signals. According to an embodiment, the split into the image and sound signals may be performed by the mobile terminal 100 or by the second electronic device 300. Further, according to an embodiment, the second content may be split into the image and sound signals by the TV and speaker, respectively.

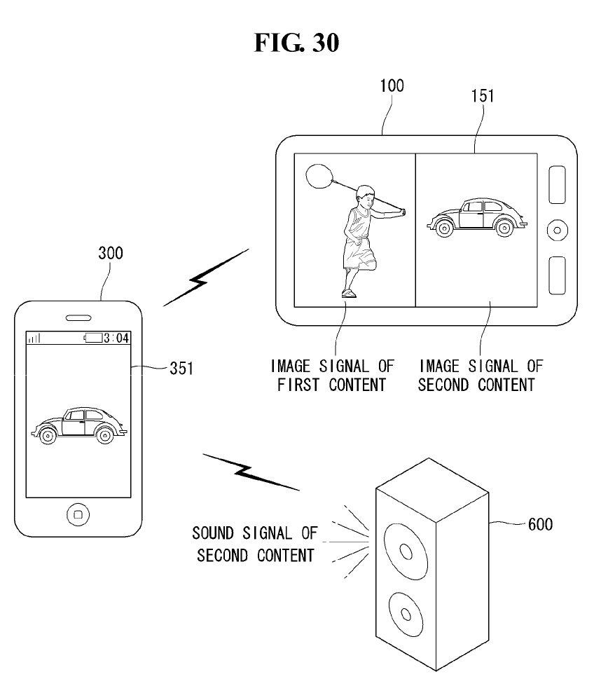

FIG. 30 illustrates an example where image and sound signals contained in the second content that is a movie file requested to play are played by different electronic devices (100 and 600), respectively. Referring to FIG. 30, the sound signal included in the second content is played by the speaker, and the image signal is played by the mobile terminal 100.

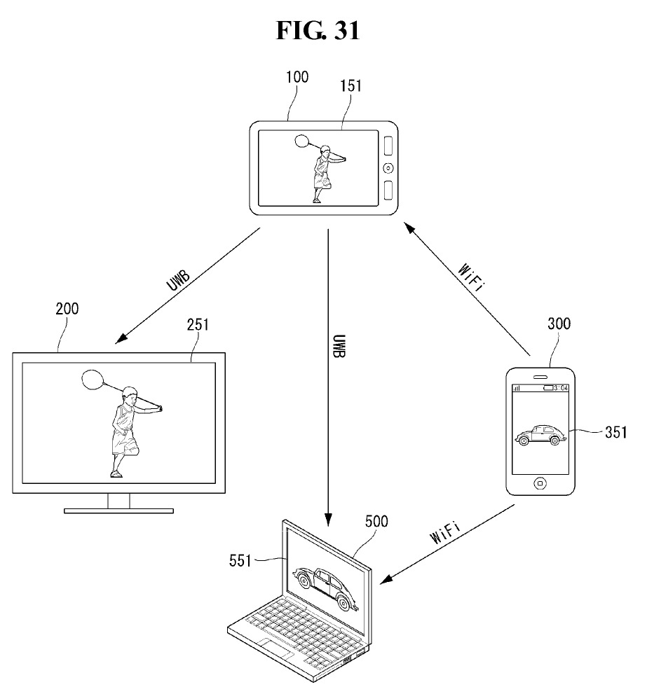

FIG. 31 illustrates an example of controlling the first and second contents using different protocols by the mobile terminal 100. Referring to FIG. 31, when receiving a request for playing the second content through a WiFi communication protocol from the second electronic device 300 while controlling the first electronic device 200 so that the first electronic device 200 plays the first content using a UWB (Ultra Wide Band) communication protocol, the mobile terminal 100 controls playback of the first content using the UWB communication protocol and playback of the second content using the WiFi communication protocol.

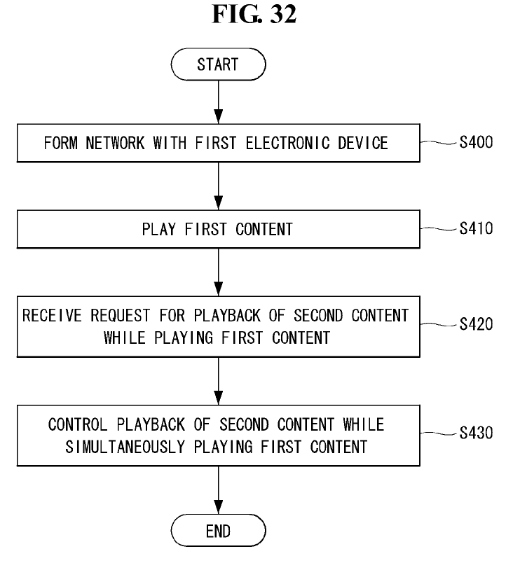

FIG. 32 is a flowchart illustrating a content playing method performed by the mobile terminal 100 according to an embodiment of this document.

First, the mobile terminal 100 plays the first content while forming a network with the second electronic device 300 (S410). As described above, the first content may be content that has been received from another electronic device through the network.

When receiving a request for playing the second content from the second electronic device 300 while playing the first content (S420), the mobile terminal 100 controls playback of the second content while playing the first content (S430).

Hereinafter, examples of controlling playback of the second content while playing the first content by the mobile terminal 100 will be described.

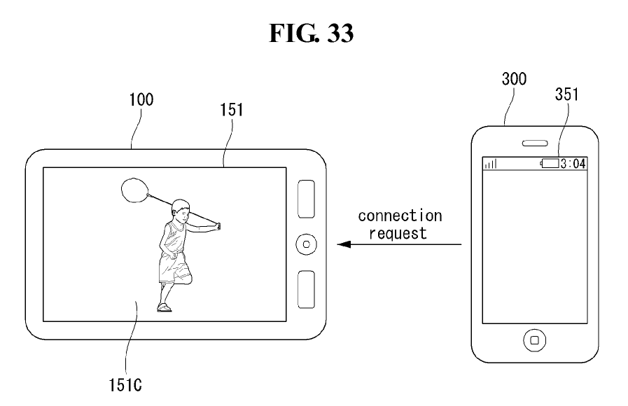

FIG. 33 illustrates an example where the mobile terminal 100 receives a connection request relating to playback of the second content according to the content playing method described in connection with FIG. 32. Referring to FIG. 33, the mobile terminal 100 receives a request for playing the second content from the second electronic device 300 while displaying the first content on the display 151 of the mobile terminal 100.

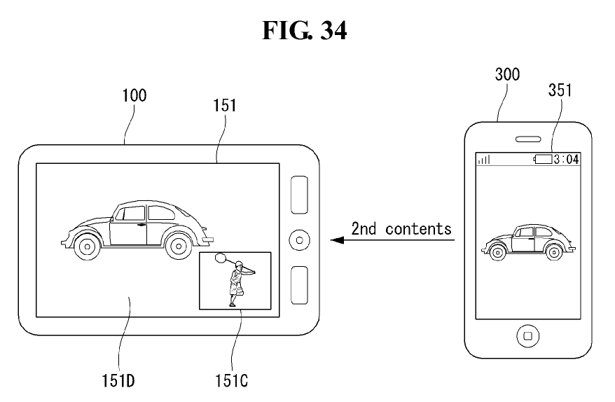

FIG. 34 illustrates an example of playing the second content according to the content playing method described in connection with FIG. 32. Referring to FIG. 34, the mobile terminal 100 receives the second content from the second electronic device 300 that has made a request to the mobile terminal 100 to play the second content and plays the first and second contents at the same time. The first and second content displaying areas 151D and 151E overlap each other on the display 151.

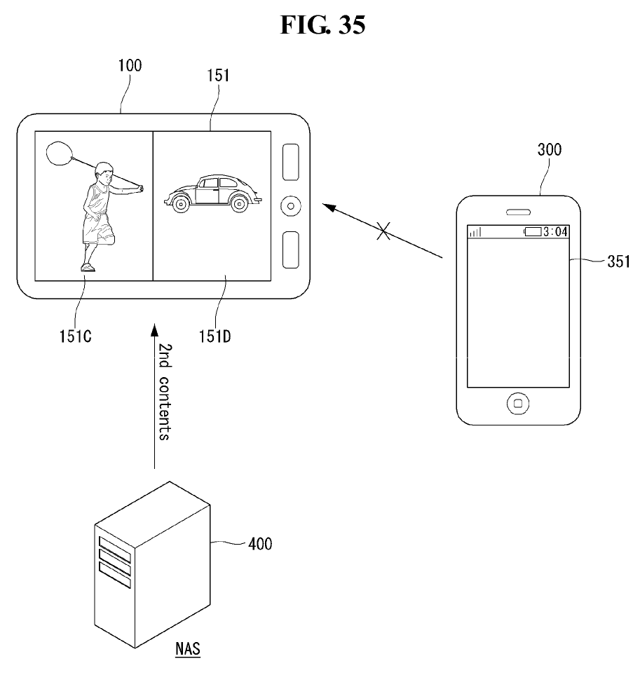

FIG. 35 illustrates an example of playing the second content according to the content playing method described in connection with FIG. 32. Referring to FIG. 35, in response to a request for playing the second content from the second electronic device 300, the mobile terminal 100 receives the second content from the electronic device 500 and plays the first and second contents.

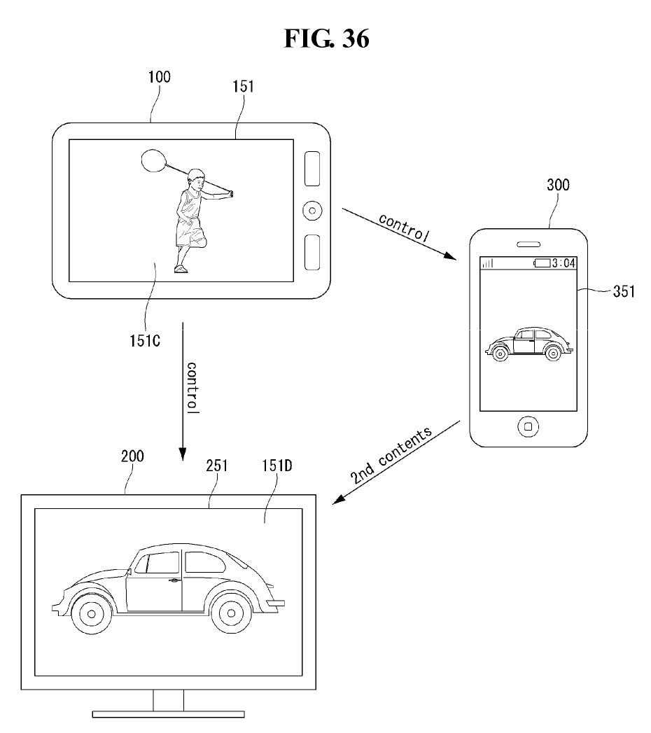

FIG. 36 illustrates an example of playing the second content according to the content playing method described in connection with FIG. 32. Referring to FIG. 36, in response to a request for playing the second content from the second electronic device 300 while playing the first content, the mobile terminal 100 controls the second electronic device 300 so that the second content is transmitted to the first electronic device 200 while continuing to play the first content and controls the first electronic device 200 so that the second content is played at the same time.

As described above, the examples have been described with reference to FIGS. 32 to 36 where the mobile terminal 100 controls playback of the second content when receiving a connection request relating to playback of the second content during playback of the first content.

Although not shown in the drawings, the embodiments described in connection with FIGS. 18 to 28, for example, the embodiments regarding the content displaying areas in receiving the connection request relating to playback of the second content during the course of playback of the first content, may also apply to the embodiments described in connection with FIGS. 32 to 36.

The application may be apparent from those described in connection with FIGS. 18 to 28 by one of ordinary skill in the art, and thus detailed description will be omitted.

Further, the embodiments described in connection with FIGS. 29 and 30, for example, the embodiments that select an electronic device to play the second content or determines a playback level of the second content based on an analysis result of resources of the mobile terminal 100 and attributes of the second content, may also apply to the embodiments described in connection with FIGS. 32 to 36. The application may be apparent from those described in connection with FIGS. 29 and 30 by one of ordinary skill in the art, and thus detailed description will be omitted.

Further, the embodiments described in connection with FIG. 31, for example, the embodiment where the 100 uses a plurality of different communication protocols for playing the first and second contents, may also apply to the embodiments described in connection with FIGS. 32 to 36. The application may be apparent from those described in connection with FIG. 31 by one of ordinary skill in the art, and thus detailed description will be omitted.

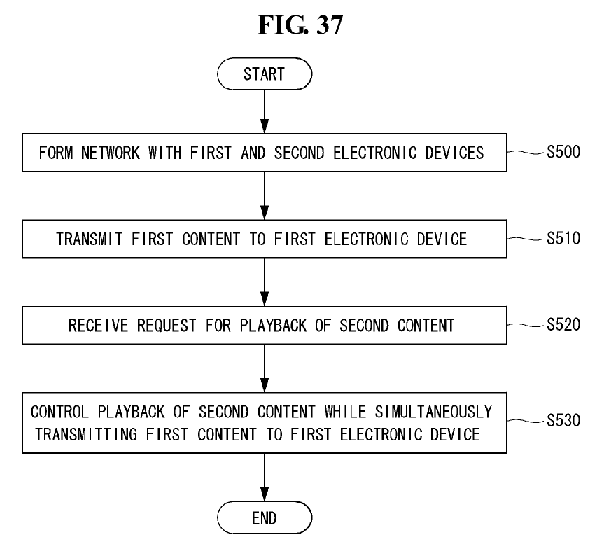

FIG. 37 is a flowchart illustrating a content playing method performed by the mobile terminal 100 according to an embodiment of this document.

First, the mobile terminal 100 forms a network with the first electronic device 200 (S500) and transmits the first content to the first electronic device 200 (S510).

When receiving a request for playing the second content from the second electronic device 300 during transmission of the first content (S520), the mobile terminal 100 controls playback of the second content while simultaneously continuing to transmit the first content (S530).

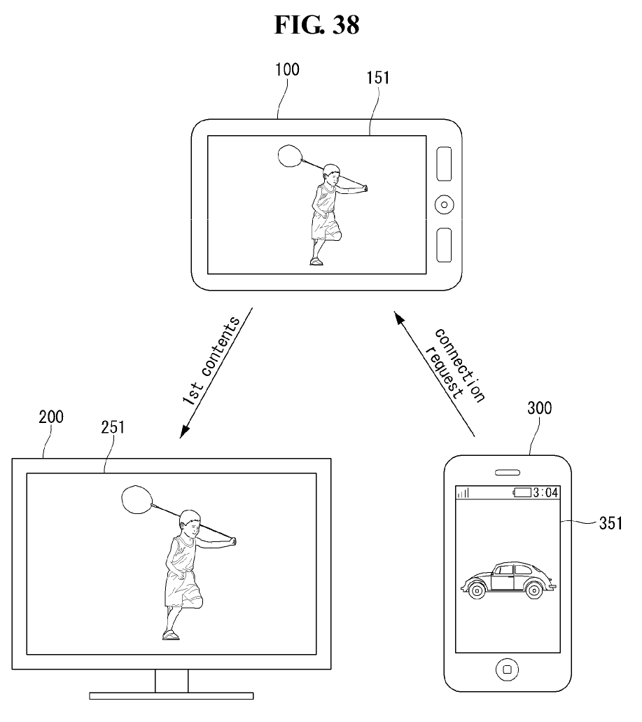

Hereinafter, examples of controlling playback of the second content while continuing the transmission of the first content by the mobile terminal 100 will be described with reference to FIGS. 38 to 41.

FIG. 38 illustrates an example where the mobile terminal 100 receives a connection request relating to playback of the second content according to the content playing method described in connection with FIG. 37. Referring to FIG. 38, the mobile terminal 100 receives a connection request relating to playback of the second content from the second electronic device 300 while transmitting the first content to the first electronic device 200.

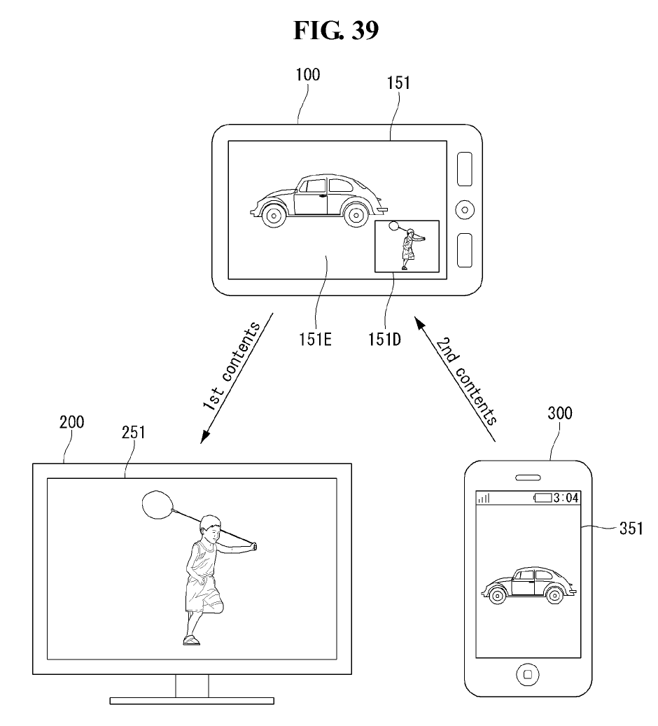

FIG. 39 illustrates an example of playing the second content according to the content playing method described in connection with FIG. 37. Referring to FIG. 39, the mobile terminal 100 receives the second content from the second electronic device 300 that has made the request for playing the second content, and plays the second content on the display 151 while transmitting the first content to the first electronic device 200.

The mobile terminal 100 displays the first content on the display 151. According to an embodiment, the first content displaying area 151D and the second content displaying area 151E may overlap each other on the display 151.

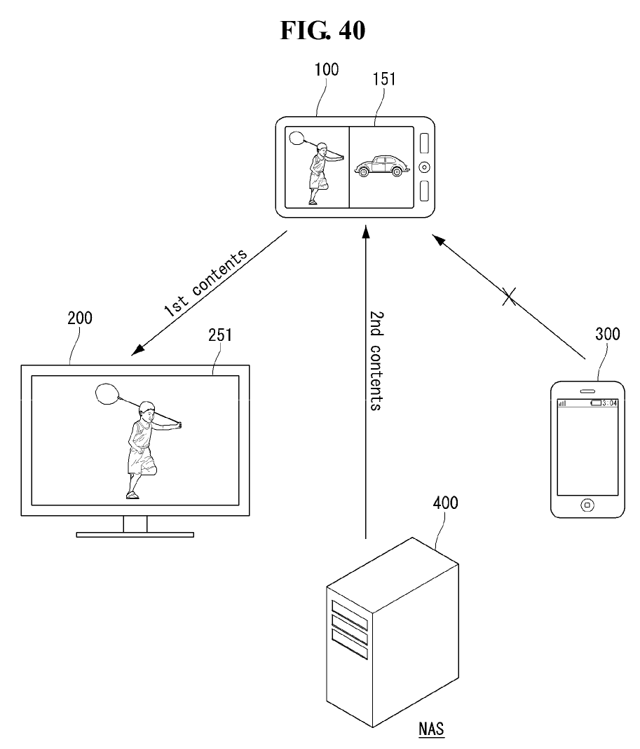

FIG. 40 illustrates an example of playing the second content according to the content playing method described in connection with FIG. 37. Referring to FIG. 40, in response to a request for playing the second content from the second electronic device 300 while transmitting the first content to the first electronic device 200, the mobile terminal 100 receives the second content from the electronic device 500 storing the second content and plays the second content on the display 151 while simultaneously transmitting the first content to the first electronic device 200.

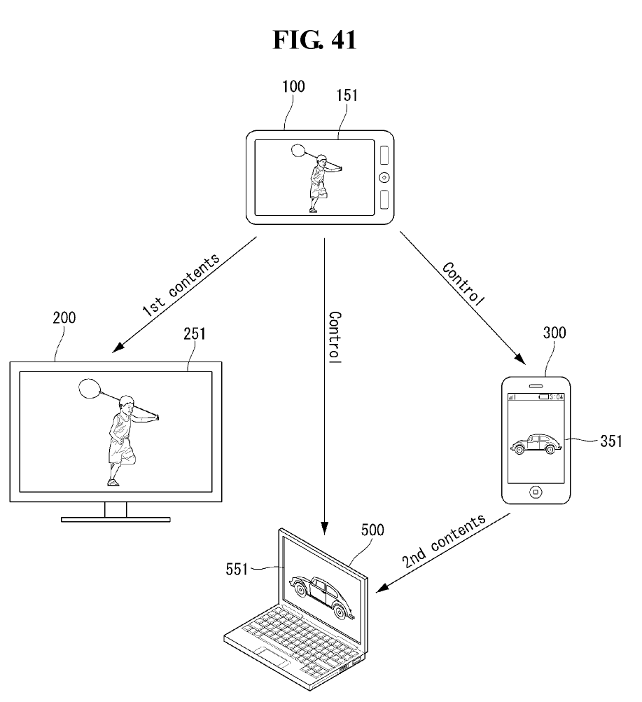

FIG. 41 illustrates an example of playing the second content according to the content playing method described in connection with FIG. 37. Referring to FIG. 41, in response to a connection request relating to playback of the second content from the second electronic device 300 while transmitting the first content to the first electronic device 200, the mobile terminal 100 continues to transmit the first content to the first electronic device 200 and controls the second electronic device 300 so that the second content is transmitted to the third electronic device 500 while simultaneously controlling the third electronic device 500 to play the transmitted second content.

With reference to FIGS. 37 to 41, the embodiments have been described where the mobile terminal 100 controls playback of the second content when receiving a connection request relating to playback of the second content while transmitting the first content to another electronic device.

Although not shown in the drawings, the embodiments described in connection with FIGS. 18 to 28, for example, the embodiments regarding the content displaying areas in receiving the connection request relating to playback of the second content during the course of playback of the first content, may also apply to the embodiments described in connection with FIGS. 37 to 41. The application may be apparent from those described in connection with FIGS. 18 to 28 by one of ordinary skill in the art, and thus detailed description will be omitted.

Further, the embodiments described in connection with FIGS. 29 and 30, for example, the embodiments that select an electronic device to play the second content or determines a playback level of the second content based on an analysis result of resources of the mobile terminal 100 and attributes of the second content, may also apply to the embodiments described in connection with FIGS. 37 to 41. The application may be apparent from those described in connection with FIGS. 29 and 30 by one of ordinary skill in the art, and thus detailed description will be omitted.

Further, the embodiments described in connection with FIG. 31, for example, the embodiment where the 100 uses a plurality of different communication protocols for playing the first and second contents, may also apply to the embodiments described in connection with FIGS. 37 to 41. The application may be apparent from those described in connection with FIG. 31 by one of ordinary skill in the art, and thus detailed description will be omitted.

Hereinafter, embodiments where the mobile terminal 100 displays a control area on the display 151 of the mobile terminal 100 to control playback of content will be described, wherein the display 151 is implemented as a touch screen.

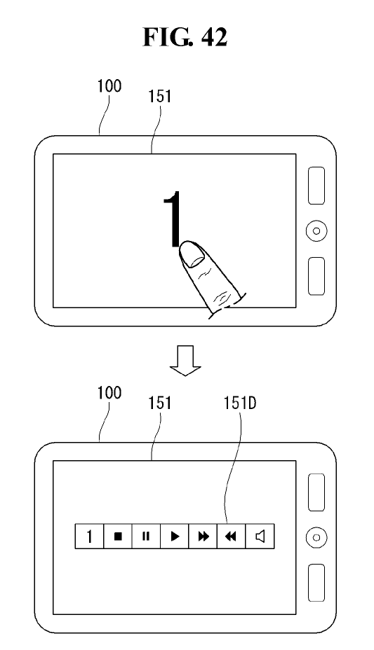

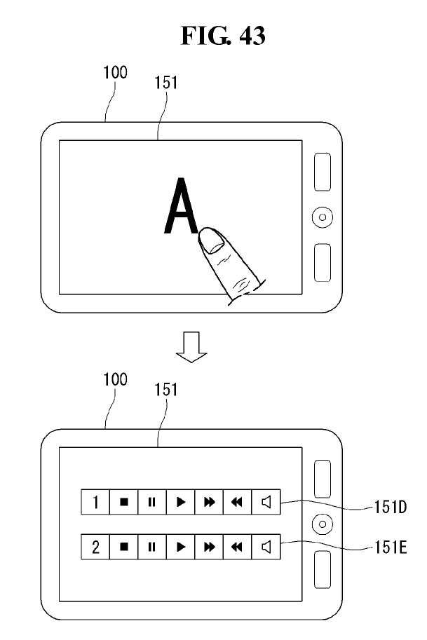

FIGS. 42 and 43 illustrates examples where the mobile terminal 100 displays a control area to control playback of content based on a handwriting input received through the display 151, which is implemented as a touch screen.

Referring to FIG. 42, if a handwriting input received through the display 151 is a number, for example “1”, the controller 180 of the mobile terminal 100 displays a control area 151D corresponding to a first electronic device on the touch screen 151. Although not shown in the drawings, if a handwriting input of a number is received through the display 151, then the controller 180 displays a control area for controlling a second electronic device on the touch screen 151.

Referring to FIG. 43, if a handwriting input received through the display 151 is a letter, for example “A”, the controller 180 displays control areas 151D and 151E for controlling the first and second electronic devices, respectively, which correspond to the letter “A”.

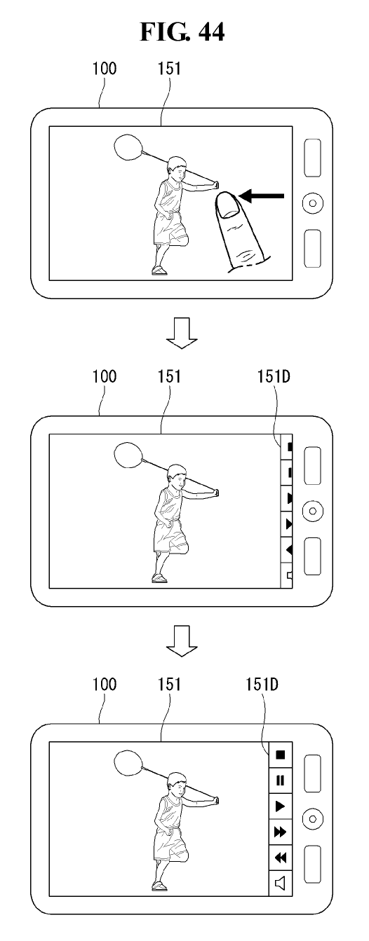

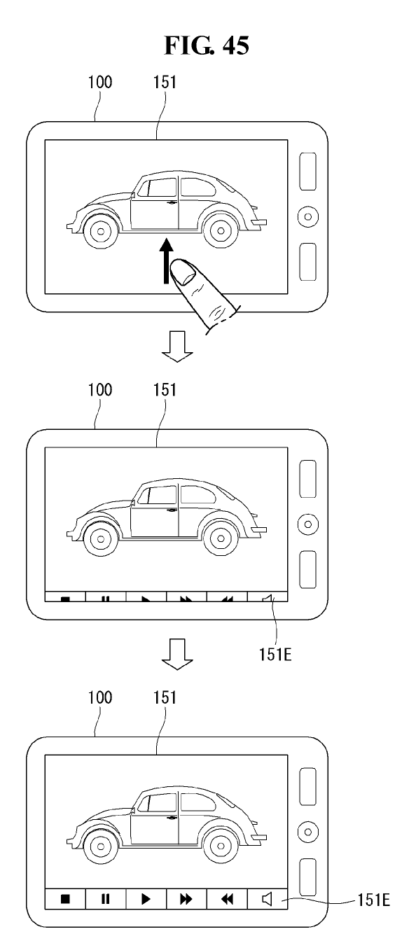

FIGS. 44 and 45 illustrate examples where the mobile terminal 100 displays a control area to control playback of content based on a location and direction of a touch received through the display 151 that is implemented as a touch screen.

Referring to FIG. 44, if a touch is moved leftward from a right portion of the touch screen 151 with particular content displayed on the touch screen 151, then a control area 151D gradually shows up on the touch screen 151 as if it moves from a right edge of the touch screen 151 to the left to control playback of the content.

Referring to FIG. 45, if a touch is moved upward from a lower portion of the touch screen 151 with particular content displayed on the touch screen 151, then a control area 151E gradually appears on the touch screen 151 as if it moves from a lower edge of the touch screen 151E upward.

The embodiments have been described in connection with FIGS. 44 and 45 where a control area corresponding to a specific image is displayed on the touch screen 151 according to a location of a touch and a travelling direction of the touch with the image is displayed on the touch screen 151. According to an embodiment, the image corresponding to the location and direction of the touch received through the display 151 may be preset irrespective of the content displayed on the display 151.

For example, according to an embodiment, the mobile terminal 100 may be preset so that if a location and move of a touch is recognized as shown in FIG. 44, a control area for controlling playback of the first content may be preset to be displayed on the touch screen 151, and so that if a location and move of a touch is recognized as shown in FIG. 45, a control area for controlling playback of the second content may be preset to be displayed on the touch screen 151.

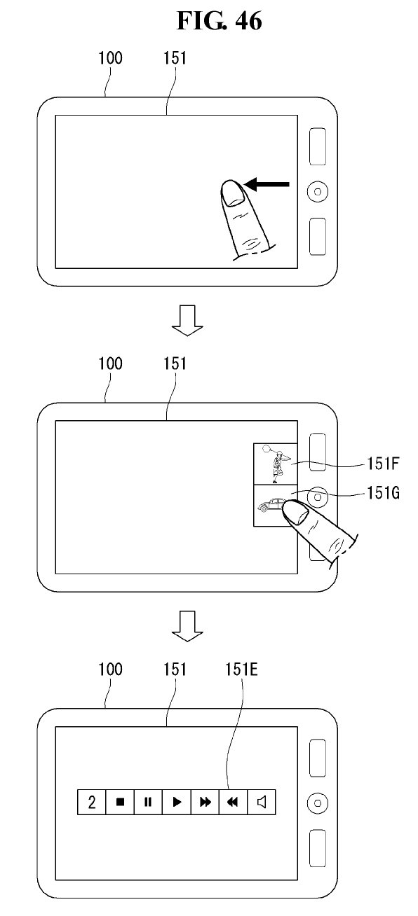

FIG. 46 illustrates a process where a control area is displayed on the touch screen 151 for content corresponding to a content identifier when the content identifier is selected from the touch screen 151 of the mobile terminal 100 in response to a touch received through the touch screen 151.

Referring to FIG. 46, if a touch is moved from a right portion of the touch screen 151 to the left, identifiers 151F and 151G for contents whose playback may be controlled by the mobile terminal 100 show up at a right edge of the touch screen 151.

Although the content identifiers have been implemented as thumbnail images of captured images of contents as shown in FIG. 46, the embodiments of this document are not limited thereto. For example, according to an embodiment, the content identifiers may include numbers or letters that are previously correspondent to the contents.

Turning back to FIG. 46, if a user touches an area including the identifier 151G with the content identifiers 151F and 151G displayed on the touch screen 151, then a control area 151E for the touched identifier 151G is displayed on the touch screen 151.

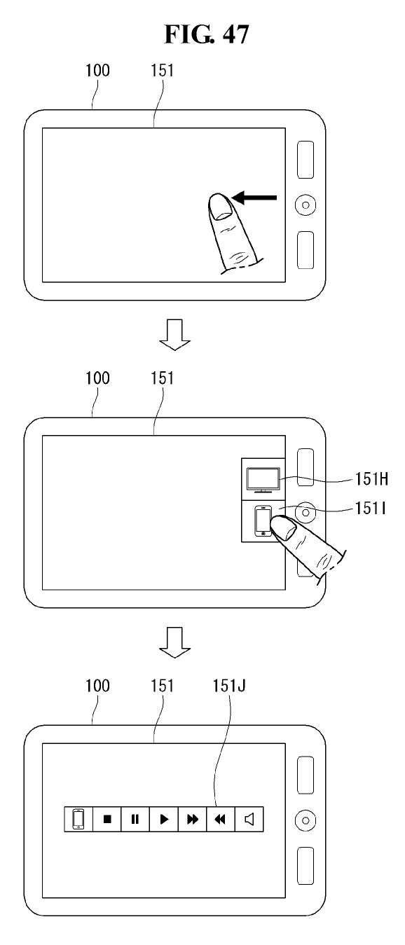

FIG. 47 illustrates a process where a control area is displayed on the touch screen 151 for content corresponding to an identifier for an electronic device when the identifier is selected from the touch screen 151 of the mobile terminal 100 in response to a touch received through the touch screen 151.

Referring to FIG. 47, if a touch is moved from a right portion of the touch screen 151 to the left, then identifiers 151H and 151I for electronic devices that may be controlled by the mobile terminal 100 appear at a right edge of the touch screen 151.

Although the identifiers have been implemented as icons of electronic device images as shown in FIG. 47, the embodiments of this document are not limited thereto. For example, according to an embodiment, the electronic device identifiers may be represented as at least numbers, letters, or combinations thereof, which are previously correspondent to the electronic devices.

Returning to FIG. 47, if a user touches the area including the identifier for the electronic device 151I with the identifiers 151H and 151I displayed on the touch screen 151, a control area 151J for the identifier 151I pops up on the touch screen 151.

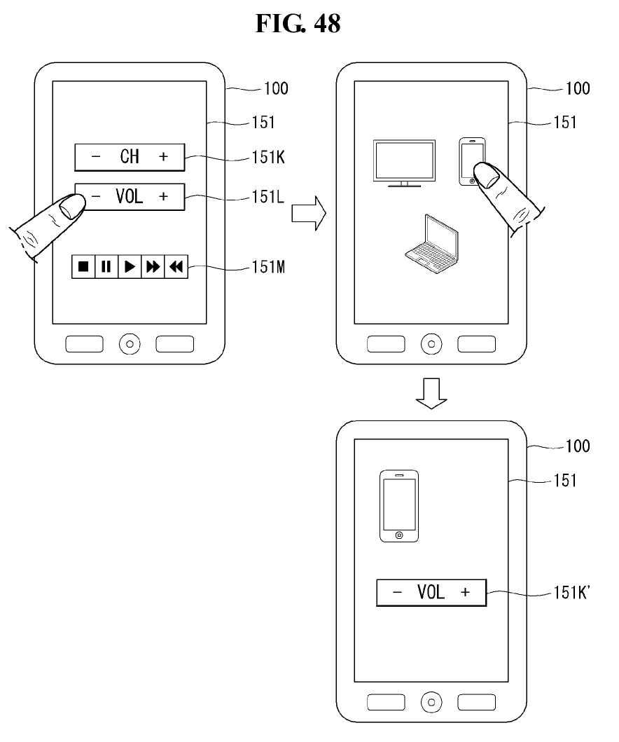

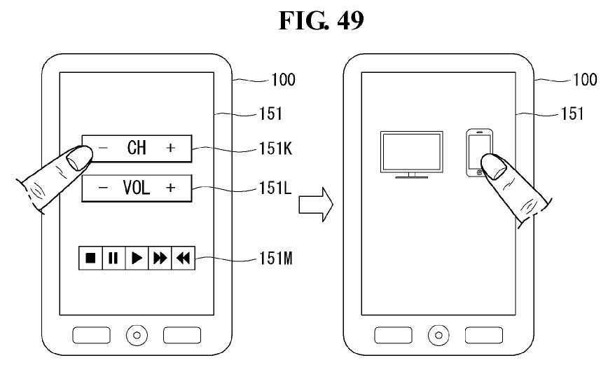

FIGS. 48 and 49 illustrate examples where the mobile terminal 100 functions as a remote controller that may control playback of content by other electronic devices. It is assumed in FIGS. 48 and 49 that a TV connected to the mobile terminal 100 plays a moving picture and a laptop computer and another mobile terminal play a DMB broadcast.

Referring to FIG. 48, if a touch is received with a channel control area 151K, a sound control area 151L, and an image playing area 151M displayed on the touch screen 151 of the mobile terminal 100, the controller 180 of the mobile terminal 100 displays all electronic devices connected to the mobile terminal 100 on the touch screen 151.

Then, a user may select one of the electronic devices displayed on the touch screen 151, and the controller 180 may display a control area on the touch screen 151 to control the sound volume of the selected electronic device.

According to an embodiment, the user may select two or more electronic devices by performing a drag on the touch screen 151 so that the controller 180 may display a control area for the selected two or more electronic devices. The same may also apply in FIG. 49.

Referring to FIG. 49, upon receiving a touch on the channel control area 151K, the controller 180 of the mobile terminal 100 displays on the touch screen 151 only a laptop computer playing content whose channel may be controlled and another mobile terminal among all of the electronic devices connected to the mobile terminal 100 since no channel control function is required for the moving picture being played by the TV connected to the mobile terminal 100.

Then, the user may select one of the electronic devices displayed on the touch screen 151, and the controller 180 may display on the touch screen 151 a control area for controlling a DMB broadcast channel being displayed by the selected electronic device.

The embodiments have been described with reference to FIGS. 48 and 49 where if a specific function among functions provided by the mobile terminal 100 serving as a remote controller is selected, among the electronic devices controlled by the mobile terminal 100, only some electronic devices that may conduct the specific function are selected displayed on the touch screen 151.

Alternately, the mobile terminal 100 may first display the electronic devices on the touch screen 151. If the user selects one of the electronic devices displayed on the touch screen 151, the controller 180 of the mobile terminal 100 may be set as a remote controller that provides only the functions that may be carried out by the selected electronic device.

For example, it is assumed that a TV, a laptop computer, and another mobile terminal are connected to the mobile terminal 100 wherein the TV plays a moving picture, and the laptop computer and the other mobile terminal play a DMB broadcast. If the user touches the laptop computer or the other mobile terminal, a control area is displayed on the touch screen 151 for channel control. However, if the user touches the TV, no control area for channel control is displayed on the touch screen 151.

The methods of playing content by the mobile terminal 100 according to the embodiments of this document may be implemented as programs that may executed by various computer means and recorded in a computer-readable medium. The computer-readable medium may contain a program command, a data file, and a data structure, alone or in a combination thereof. The program recorded in the medium may be one specially designed or configured for the embodiments of this document or one known to those of ordinary skill in the art.

Examples of the computer-readable medium may include magnetic media, such as hard disks, floppy disks, or magnetic tapes, optical media, such as CD-ROMs or DVDs, magneto-optical media, such as floptical disks, ROMs, RAMs, flash memories, or other hardware devices that are configured to store and execute program commands. Examples of the program may include machine language codes such as those made by a compiler as well as high-class language codes executable by a computer using an interpreter. The above-listed hardware devices may be configured to operate as one or more software modules to perform the operations according to the embodiments of this document, and vice versa.

This document has been explained above with reference to exemplary embodiments. It will be evident to those skilled in the art that various modifications may be made thereto without departing from the broader spirit and scope of this document. Further, although this document has been described in the context its implementation in particular environments and for particular applications, those skilled in the art will recognize that this document's usefulness is not limited thereto and that this document can be beneficially utilized in any number of environments and implementations. The foregoing description and drawings are, accordingly, to be regarded in an illustrative rather than a restrictive sense.

What is claimed is:

1. An electronic apparatus comprising:
a communication unit configured to communicate with first and second electronic devices;
a controller configured to generate instructions that control playback of first content by the first electronic device;
an output interface configured to output the instructions to the first electronic device;
a controller interface configured to receive a request from a second electronic device relating to playback of second content on the apparatus; and
a display unit,
wherein the controller is configured to receive the request from the second electronic device concurrently with controlling the first electronic device to play the first content.

2. The apparatus of claim 1, wherein the display unit is configured to play the second content at least while the controller controls the first electronic device to play the first content.

3. The apparatus of claim 1, wherein the display unit is configured to play the second content in accordance with the request.

4. The apparatus of claim 1, wherein the request comprises control information from the second electronic device relating to the playback of the second content on the apparatus.

5. The apparatus of claim 1, wherein the output interface is configured to output the first content with the instructions to the first electronic device.

6. The apparatus of claim 1, wherein the first electronic device comprises a television, the apparatus comprises a tablet device, and the second electronic device comprises a phone device.

7. The apparatus of claim 1, wherein the first electronic device comprises a television, the apparatus comprises a phone device, and the second electronic device comprises a tablet device.

8. The apparatus of claim 1, wherein the first electronic device comprises a phone device, the apparatus comprises a television, and the second electronic device comprises a tablet device.

9. The apparatus of claim 1, wherein the first electronic device comprises a phone device, the apparatus comprises a tablet device, and the second electronic device comprises a television.

10. The apparatus of claim 1, wherein the first electronic device comprises a tablet device, the apparatus comprises a phone device, and the second electronic device comprises a television.

11. The apparatus of claim 1, wherein the first electronic device comprises a tablet device, the apparatus comprises a television, and the second electronic device comprises a phone device.

12. The apparatus of claim 1, further comprising:
a storage device configured to store the first content, wherein the controller is configured to transmit the first content stored in the storage to the first electronic device and the controller is configured to control the first electronic device so that the first electronic device plays the first content.

13. The apparatus of claim 1, wherein the controller is configured to control a third electronic device to transmit the first content to the first electronic device and the controller is configured to control the first electronic device to play the transmitted first content.

14. The apparatus of claim 1, wherein responsive to receiving the request relating to playback of the second content from the second electronic device while controlling the first electronic device so that the first electronic device plays the first content, the controller is configured to receive the second content stored in the second electronic device and the controller is configured to output the second content through the output interface of the electronic device.

15. The apparatus of claim 1, wherein responsive to receiving the request relating to playback of the second content from the second electronic device while controlling the first electronic device so that the first electronic device plays the first content, the controller is configured to receive the second content from a fourth electronic device and the controller is configured to control playback of the second content through the output interface of the electronic device.

16. The apparatus of claim 1, wherein responsive to receiving the request relating to playback of the second content from the second electronic device while controlling the first electronic device so that the first electronic device plays the first content, the controller is configured to control display of a selection area for selecting an electronic device for playing the second content among at least one electronic device on the output interface of the electronic device.

17. The apparatus of claim 1, wherein responsive to receiving the request relating to playback of the second content from the second electronic device while controlling the first electronic device so that the first electronic device plays the first content, the controller is configured to transmit information on a third electronic device that is configured to play the second content to the second electronic device.

18. The apparatus of claim 1, wherein the display unit comprises a first display area and a second display area, and
wherein responsive to receiving the request relating to playback of the second content from the second electronic device while controlling the first electronic device so that the first electronic device plays the first content, the controller is configured to display the first content on a first displaying area of the display unit of the electronic device and the controller is configured to display the second content on the second displaying area of the display unit.

19. The apparatus of claim 18,
wherein the controller is configured to detect when playback of one of the first and second contents is terminated, and
wherein responsive to detecting that playback of one of the first and second contents is terminated, the controller is configured to vary a playing area corresponding to playing content to include a displaying area corresponding to the terminated content.

20. The apparatus of claim 1, wherein the controller is configured to control a display of a control area for controlling playback of at least one of the first and second contents on an output device of the electronic device, wherein the control area comprises a transparency, and wherein the transparency of the control area is variable with time.

21. The apparatus of claim 1,
wherein the display unit comprises a touch screen,
wherein the controller is configured to receive information related to a touch received through the touch screen,
wherein the controller is configured to generate information to display, at least on the touch screen included in the display unit of the electronic device, a control area for controlling playback of the first and second contents based on receiving the information related to the touch received through the touch screen, and
wherein the controller is configured to control playback of the content through the control area as a function of a location of the touch on the touch screen.

22. The apparatus of claim 1,
wherein responsive to receiving the request relating to playback of the second content from the second electronic device while controlling the first electronic device so that the first electronic device plays the first content, the controller is configured to select at least one electronic device to play the second content, and
wherein the controller is configured to perform the selection at least based upon considering at least one of a resource of the electronic device and attribute information of the second content.

23. The apparatus of claim 1, wherein responsive to receiving the request relating to playback of the second content from the second electronic device while controlling the first electronic device so that the first electronic device plays the first content, the controller is configured to adjust a playing level of the second content, and
wherein the controller is configured to perform the adjustment at least based upon considering a resource of the electronic device and attribute information of the second content.

24. The apparatus of claim 1, wherein the controller is configured to control the second content using at least one communication protocol that is different from a communication protocol for controlling playback of the first content.

25. An electronic apparatus comprising:
a communication unit configured to communicate with a first electronic device;
a controller configured to generate instructions that control playback of first content by the first electronic device;
an output interface configured to output the instructions to the first electronic device;
a controller interface configured to receive a request from the first electronic device relating to playback of second content; and
a display unit,
wherein the controller is configured to receive the request relating to the playback of the second content from the first electronic device concurrently with controlling the play of the first content through the output interface.

26. The apparatus of claim 25, further comprising:
a storage device configured to store the first content, wherein the controller is configured to play the first content stored in the storage through the output interface.

27. The apparatus of claim 25, wherein the controller is configured to receive the first content from a second electronic device and play the first content through the output interface.

28. The apparatus of claim 25, wherein responsive to receiving the request relating to playback of the second content from the first electronic device while playing the first content through the output interface, the controller is configured to utilize instructions to play the first content through the output interface while simultaneously receiving the second content stored in the first electronic device to play the second content through the output interface.

29. The apparatus of claim 25, wherein responsive to receiving the request relating to playback of the second content from the first electronic device while playing the first content through the output interface, the controller is configured to utilize instructions to play the first content through the output interface while simultaneously receiving the second content from a third electronic device to play the second content through the output interface.

30. The apparatus of claim 25, wherein responsive to receiving the request relating to playback of the second content from the first electronic device while playing the first content through the output interface, the controller is configured to utilize instructions to display a selection area for selecting an electronic device to play the second content among at least one electronic device on the output interface of the electronic device.

31. The apparatus of claim 25, wherein responsive to receiving the request relating to playback of the second content from the first electronic device while playing the first content through the output interface, the controller is configured to transmit information on a third electronic device that is configured to play the second content to a second electronic device.

32. The apparatus of claim 25, wherein responsive to receiving the request relating to playback of the second content from the first electronic device while playing the first content through the output interface, the controller is configured to utilize instructions to display the first content on a first displaying area of the display unit of the electronic device and display the second content on a second displaying area of the display unit.

33. The apparatus of claim 32, wherein responsive to the playback of one of the first and second contents being terminated, the controller is configured to utilize instructions to vary a playing area corresponding to playing content to include a displaying area corresponding to the terminated content.

34. The apparatus of claim 25, wherein the controller is configured to utilize instructions to display a control area for controlling playback of the first and second contents on the display unit of the electronic device, wherein a transparency of the control area is variable with time.

35. The apparatus of claim 25, wherein responsive to receiving the request relating to playback of the second content from the first electronic device while playing the first content through the output interface, the controller is configured to utilize instructions to select at least one electronic device to play the second content while considering at least one of a resource of the electronic device and attribute information of the second content.

36. The apparatus of claim 25, wherein responsive to receiving the request relating to playback of the second content from the first electronic device while playing the first content through the output interface, the controller is configured to adjust a playing level of the second content while considering a resource of the electronic device and attribute information of the second content.

37. The apparatus of claim 25, wherein the controller is configured to control the second content using at least one communication protocol different from a communication protocol used for controlling playback of the first content.

38. An electronic apparatus comprising:
a communication unit configured to communicate with first and second electronic devices;
a controller configured to generate instructions related to first content to play on the first electronic device;
an output interface configured to output the instructions to the first electronic device;
a controller interface configured to receive a request from a second electronic device relating to playback of second content on the apparatus; and
a display unit,
wherein the controller is configured to receive the request from the second electronic device concurrently with transmitting the instructions for the first content to the first electronic device.

39. The apparatus of claim 38, wherein responsive to receiving the request relating to the playback of the second content from the second electronic device while transmitting the first content to the first electronic device, the controller is configured to transmit the first content to the first electronic device while simultaneously receiving the second content that is stored in the second electronic device to play the second content through the output interface.

40. The apparatus of claim 38, wherein responsive to receiving the request relating to the playback of the second content from the second electronic device while transmitting the first content to the first electronic device, the controller is configured to transmit the first content to the first electronic device while simultaneously receiving the second content from a third electronic device to play the second content through the output interface.
